(19) United States
(12) Patent Application Publication
(10) Pub. No.: US 2024/0357653 A1
(43) Pub. Date: Oct. 24, 2024

(54) SENSING REPORTING METHOD AND DEVICE

(71) Applicant: GUANGDONG OPPO MOBILE TELECOMMUNICATIONS CORP., LTD, Dongguan (CN)

(72) Inventors: Chaoming LUO, Dongguan (CN); Lei HUANG, Singapore (SG)

(73) Assignee: GUANGDONG OPPO MOBILE TELECOMMUNICATIONS CORP., LTD, Dongguan (CN)

(21) Appl. No.: 18/755,588

(22) Filed: Jun. 26, 2024

Related U.S. Application Data
(63) Continuation of application No. PCT/CN2022/076899, filed on Feb. 18, 2022.
Application No. PCT/CN2022/076899 is a continuation of application No. PCT/CN2022/070826, filed on Jan. 7, 2022.

(51) Int. Cl. H04W 74/0816; H04W 24/10

(52) U.S. Cl. CPC H04W 74/0816; H04W 24/10

(57) ABSTRACT

Disclosed are a sensing reporting method and a device, and the method includes: transmitting, by a first device, a first report frame to a second device, where the first report frame includes a measurement result of at least one measurement instance, a measurement result of each measurement instance includes a measurement result of at least one sensing signal receiver, the at least one measurement instance corresponds to at least one measurement setup, and the at least one measurement setup is established by the first device working as a proxy of the second device.

### CROSS-REFERENCE TO RELATED APPLICATIONS

This application is a continuation of International Application No. PCT/CN2022/076899, filed on Feb. 18, 2022, which is a continuation-in-part application of PCT Patent Application No. PCT/CN2022/070826, filed with the China National Intellectual Property Administration on Jan. 7, 2022. The disclosures of the aforementioned applications are hereby incorporated by reference in their entireties.

### TECHNICAL FIELD

Embodiments of this application relate to the field of communications, and specifically to a sensing reporting method and a device.

### BACKGROUND

Sensing is a function enhancement proposed by the 802.11bf standard in the protocol 802.11, according to which surroundings are measured and sensed through wireless signals, so that various functions such as detection of indoor intrusion, movement, falls, and the like, gesture recognition, and creation of a spatial three-dimensional image can be implemented. In some scenarios, introduction of sensing by proxy is considered, that is, a device (for example, a station device) can establish a sensing process by using another device (an access point device) working as a proxy. In this case, how a proxy device reports a sensing measurement result is an urgent problem to be solved.

### SUMMARY

This application provides a sensing reporting method and a device, and a sensing by proxy device may report, to a sensing by proxy requester, one or more measurement results of one or more measurement instances corresponding to a measurement setup established by a proxy, thereby being capable of implementing sensing by proxy reporting.

According to a first aspect, a sensing reporting method is provided and includes: transmitting, by a first device, a first report frame to a second device, where the first report frame includes one or more measurement results of at least one measurement instance, the one or more measurement results of each measurement instance include one or more measurement results of at least one sensing signal receiver, the at least one measurement instance corresponds to at least one measurement setup, and the at least one measurement setup is established by the first device working as a proxy of the second device.

According to a second aspect, a sensing reporting method is provided and includes: receiving, by a second device, a first report frame transmitted by a first device, where the first report frame includes one or more measurement results of at least one measurement instance, the one or more measurement results of each measurement instance include one or more measurement results of at least one sensing signal receiver, the at least one measurement instance corresponds to at least one measurement setup, and the at least one measurement setup is established by the first device working as a proxy of the second device.

According to a third aspect, a sensing device is provided and configured to execute the method according to the first aspect or implementations of the first aspect. Specifically, the sensing device includes a functional module configured to execute the method according to the first aspect or implementations of the first aspect.

According to a fourth aspect, a sensing device is provided and configured to execute the method according to the second aspect or implementations of the second aspect. Specifically, the sensing device includes a functional module configured to execute the method according to the second aspect or implementations of the second aspect.

According to a fifth aspect, a sensing device is provided, including a processor and a memory. The memory is configured to store a computer program, and the processor is configured to invoke the computer program stored in the memory and run the computer program, to cause the sensing device to execute the method according to the first aspect or implementations of the first aspect.

According to a sixth aspect, a sensing device is provided, including a processor and a memory. The memory is configured to store a computer program, and the processor is configured to invoke the computer program stored in the memory and run the computer program, to cause the sensing device to execute the method according to the second aspect or implementations of the second aspect.

According to a seventh aspect, a chip is provided, and is configured to implement the method according to any one of the first aspect and the second aspect or implementations of the first aspect and the second aspect. Specifically, the chip includes a processor, configured to invoke a computer program from a memory and run the computer program, to cause a device on which the apparatus is installed to execute the method according to any one of the first aspect and the second aspect or implementations of the first aspect and the second aspect.

According to an eighth aspect, a computer-readable storage medium is provided, and is configured to store a computer program, where the computer program causes a computer to execute the method according to any one of the first aspect and the second aspect or implementations of the first aspect and the second aspect.

According to a ninth aspect, a computer program product is provided, including computer program instructions, where the computer program instructions cause a computer to execute the method according to any one of the first aspect and the second aspect or implementations of the first aspect and the second aspect.

According to a tenth aspect, a computer program is provided, and when the computer program runs on a computer, the computer executes the method according to any one of the first aspect and the second aspect or implementations of the first aspect and the second aspect.

According to the foregoing technical solutions, a sensing by proxy device transmits, to a sensing by proxy requester by using a first report frame, one or more measurement results of the one or more measurement instances corresponding to a measurement setup established by a proxy, thereby implementing sensing by proxy reporting.

### BRIEF DESCRIPTION OF DRAWINGS

FIG. 1 is a schematic diagram of an architecture of a communications system according to an embodiment of this application.

FIG. 2 is a schematic diagram of a Wi-Fi sensing process.

FIG. 3 is a schematic interaction diagram of a sensing measurement setup phase according to an embodiment of this application.

FIG. 4 is a schematic interaction diagram of a sensing measurement phase according to an embodiment of this application.

FIG. 5 is a schematic interaction diagram of a sensing reporting phase according to an embodiment of this application.

FIG. 6 is a schematic interaction diagram of a sensing measurement phase and a sensing reporting phase according to an embodiment of this application.

FIG. 7 is a schematic interaction diagram of another sensing measurement phase according to an embodiment of this application.

FIG. 8 is a schematic interaction diagram of a sensing reporting method according to an embodiment of this application.

FIG. 9 is a schematic interaction diagram of a sensing by proxy process according to an embodiment of this application.

FIG. 10 to FIG. 20 are schematic interaction diagrams of a sensing reporting method according to a first reporting manner.

FIG. 21 and FIG. 22 are schematic interaction diagrams of a sensing reporting method according to a second reporting manner.

FIG. 23 and FIG. 24 are schematic interaction diagrams of a sensing reporting method according to a second reporting manner.

FIG. 25 is a schematic diagram of triggering reporting according to an embodiment of this application.

FIG. 26 is a schematic diagram of a frame format of a first report frame according to an embodiment of this application.

FIG. 27 is a schematic diagram of a frame format of another first report frame according to an embodiment of this application.

FIG. 28 is a schematic diagram of a frame format of a yet another first report frame according to an embodiment of this application.

FIG. 29 is a schematic diagram of a frame format of a yet another first report frame according to an embodiment of this application.

FIG. 30 is a schematic diagram of a format of a protected report frame indicated by using a CCMP header according to an embodiment of this application.

FIG. 31 is a schematic diagram of a format of a protected report frame indicated by using a GCMP header according to an embodiment of this application.

FIG. 32 is a schematic block diagram of a sensing device according to an embodiment of this application.

FIG. 33 is a schematic block diagram of another sensing device according to an embodiment of this application.

FIG. 34 is a schematic block diagram of a communications device according to an embodiment of this application.

FIG. 35 is a schematic block diagram of a chip according to an embodiment of this application.

FIG. 36 is a schematic block diagram of a communications system according to an embodiment of this application.

### DESCRIPTION OF EMBODIMENTS

The following describes the technical solutions in embodiments of this application with reference to the accompanying drawings in embodiments of this application. Apparently, the described embodiments are some rather than all of embodiments of this application. For embodiments of this application, all other embodiments obtained by a person of ordinary skill in the art without creative efforts fall within the protection scope of this application.

The technical solutions in embodiments of this application may be applied to various communications systems, for example, wireless local area network (WLAN), wireless fidelity (Wi-Fi), or another communications system.

For example, a communications system 100 to which an embodiment of this application is applied is shown in FIG. 1. The communications system 100 may include an access point (AP) 110 and stations (STA) 120 that access a network by using the access point 110.

In some scenarios, an AP is referred to as an AP STA. That is, in a sense, the AP is also a STA.

In some scenarios, a STA is referred to as a non-AP STA.

Communication in the communications system 100 may be communication between an AP and a non-AP STA, or may be communication between a non-AP STA and a non-AP STA, or communication between a STA and a peer STA, where the peer STA may refer to a device that performs peer-to-peer communication with the STA, for example, the peer STA may be an AP, or may be a non-AP STA.

An AP is equivalent to a bridge that connects a wired network and a wireless network. A major function of the AP is to connect clients in a wireless network together and then connect the wireless network to an Ethernet. An AP device may be a terminal device (for example, a mobile phone) or a network device (for example, a router) that has a Wi-Fi chip.

It should be understood that a role of a STA in a communications system is not fixed. For example, in some scenarios, when a mobile phone is connected to a route, the mobile phone is a non-AP STA; when the mobile phone serves as a hotspot of another mobile phone, the mobile phone serves as an AP.

The AP and the non-AP STA may be devices applied in vehicle-to-everything; internet of things nodes, sensors, and the like in internet of things (IoT); intelligent cameras, intelligent remote controls, intelligent water meters, intelligent electricity meters, and the like in smart home; and sensors and the like in smart city.

In some embodiments, the non-AP STA may support an 802.11be standard. The non-AP STA may also support a plurality of current and future wireless local area network (WLAN) standards of an 802.11 family, such as 802.11ax, 802.11ac, 802.11n, 802.11g, 802.11b, and 802.11a.

In some embodiments, the AP may be a device that supports the 802.11be standard. The AP may alternatively be a device that supports a plurality of current and future WLAN standards of the 802.11 family, such as 802.11ax, 802.11ac, 802.11n, 802.11g, 802.11b, and 802.11a.

In embodiments of this application, the STA may be a device that supports a WLAN or Wi-Fi technology, such as a mobile phone, a pad, a computer, a virtual reality (VR) device, an augmented reality (AR) device, a wireless device in industrial control, a set-top box, a wireless device in self-driving, a vehicle-mounted communications device, a wireless device in remote medical, a wireless device in smart grid, a wireless device in transportation safety, a wireless device in smart city, a wireless device in smart home, a wireless communications chip, an ASIC, a SoC, or the like.

Frequency bands supported in a WLAN technology may include but are not limited to a low frequency band (such as 2.4 GHZ, 5 GHZ, or 6 GHZ) and a high frequency band (for example, 60 GHz).

FIG. 1 exemplarily shows one AP STA and two non-AP STAs. Optionally, the communications system 100 may include a plurality of AP STAs and another quantity of non-AP STAs. This is not limited in embodiments of this application.

It should be understood that in embodiments of this application, a device having a communication function in a network or a system may be referred to as a communications device. The communications system 100 shown in FIG. 1 is used as an example. A communications device may include the access point 110 and the stations 120 that have a communication function. The access point 110 and the stations 120 may be specific devices described above. Details are not described herein again. The communications device may further include another device in the communications system 100, such as a network controller, a gateway, or another network entity, which is not limited in embodiments of this application.

It should be understood that the terms “system” and “network” may often be used interchangeably herein. In this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that, the “indication” mentioned in embodiments of this application may be a direct indication or an indirect indication, or indicate an association. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association between A and B.

In the description of embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “predefining” may be implemented in a manner in which corresponding code, a table, or other related information used for indication is pre-stored in a device (for example, including an access point and a station). A specific implementation is not limited in this application. For example, pre-defining may refer to being defined in a protocol.

To facilitate understanding of the technical solutions of embodiments of this application, relevant terms of this application are explained below.

Association identifier (AID) is used to identify a terminal that has established an association with an access point.

Medium access control (MAC) is a short name of medium access control address.

Transmission opportunity (TXOP) refers to a period of time during which a terminal with the transmission opportunity may actively initiate one or more transmissions.

Burst generally refers to a short period of time during which one or more signals are transmitted.

Burst group refers to a combination of one or more bursts. Bursts in a same burst group generally have some common features.

Sensing measurement is to sense people or objects in an environment by measuring changes in a signal after the signal is scattered and/or reflected by people or objects. That is, sensing measurement is to measure and sense a surrounding environment through wireless signals, so that various functions such as detection of indoor intrusion, movement, falls, and the like, gesture recognition, and creation of a spatial three-dimensional image may be implemented.

Devices involved in sensing measurement may include the following roles:
a sensing initiator: a device that initiates a sensing session and expects to obtain a sensing result;
a sensing responder: a device that is not a sensing initiator and participates in a sensing session;
a sensing transmitter: a device that initiates a sensing measurement signal (sensing illumination signal), or referred to as a sensing signal transmitter;
a sensing receiver: a device that receives a sensing measurement signal (sensing illumination signal), or referred to as a sensing signal receiver;
a sensing processor: a device that processes a sensing measurement result; and
a sensing participant, including a sensing initiator, a sensing transmitter and a sensing receiver.

A device may have one or more roles in one sensing measurement. For example, a sensing initiator may be only a sensing initiator, or may also be a sensing transmitter, or may also be a sensing receiver, or may also be both a sensing transmitter and a sensing receiver.

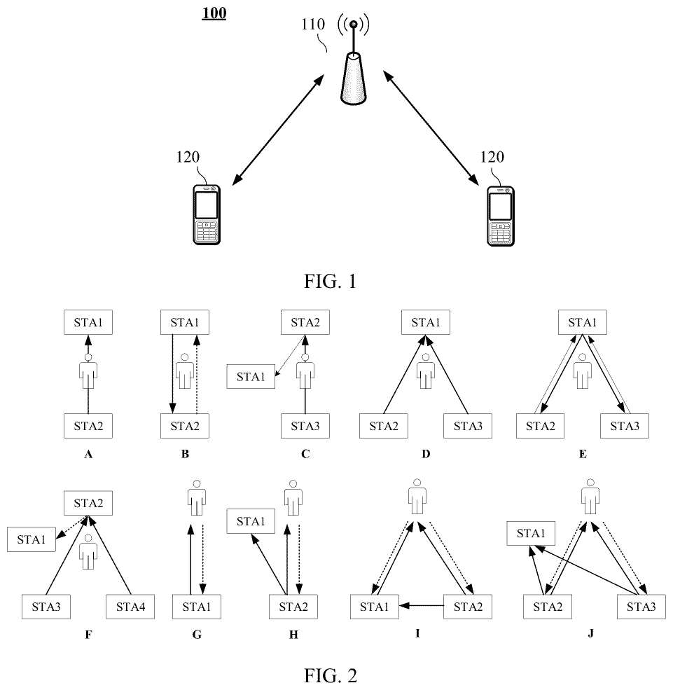

For example, as shown in A of FIG. 2, a STA1 may be a sensing initiator, may be a sensing receiver, or may be a sensing processor; and a STA2 may be a sensing transmitter.

For another example, as shown in B of FIG. 2, a STA1 may be a sensing initiator, or may be a sensing transmitter; and a STA2 may be a sensing receiver or a sensing processor.

For another example, as shown in C of FIG. 2, a STA1 may be a sensing initiator, or may be a sensing processor; a STA2 may be a sensing receiver; and a STA3 may be a sensing transmitter.

For another example, as shown in D of FIG. 2, a STA1 may be a sensing initiator, may be a sensing receiver, or may be a sensing processor; a STA2 may be a sensing transmitter; and a STA3 may be a sensing transmitter.

For another example, as shown in E of FIG. 2, a STA1 may be a sensing initiator, may be a sensing transmitter, or may be a sensing processor; a STA2 may be a sensing receiver; and a STA3 may a sensing receiver.

For another example, as shown in F of FIG. 2, a STA1 may be a sensing initiator; a STA2 may be a sensing receiver, or may be a sensing processor; a STA3 may be a sensing transmitter; and a STA4 may be a sensing transmitter.

For another example, as shown in G of FIG. 2, a STA1 may be a sensing initiator, may be a sensing transmitter, may be a sensing receiver, or may be a sensing processor.

For another example, as shown in H of FIG. 2, a STA1 may be a sensing initiator; a STA2 may be a sensing transmitter, may be a sensing receiver, or may be a sensing processor.

For another example, as shown in I of FIG. 2, a STA1 may be a sensing initiator, may be a sensing transmitter, may be a sensing receiver, or may be a sensing processor; and a STA2 may be a sensing transmitter, or may be a sensing receiver.

For another example, as shown in J of FIG. 2, a STA1 may be a sensing initiator, or may be a sensing processor; a STA2 may be a sensing transmitter, or may be a sensing receiver; and a STA3 may be a sensing transmitter, or may be a sensing receiver.

It should be noted that FIG. 2 is merely an example of this application and should not be construed as a limitation to this application. For example, the STA1, the STA2, and the STA3 in FIG. 2 only represent roles of a STA. In FIG. 2 and subsequent steps such as sensing session and measurement, a quantity of STAs is not limited. For example, roles represented by the STA1, the STA2, and the STA3 may be implemented as one or more STAs.

In some embodiments, there may be a plurality of sensing types. For example, there is a sensing type based on channel state information (CSI), namely, CSI-based Sensing. In this sensing type, a sensing measurement result is obtained by processing CSI of a received sensing measurement signal. For another example, there is a sensing type based on a reflection signal, namely, Radar-based Sensing. In this sensing type, a sensing measurement result is obtained by processing a reflection signal of a received sensing measurement signal.

In embodiments of this application, the sensing initiator is also referred to as an initiating device or a sensing session initiator, and the sensing responder is also referred to as a responding device, or a sensing session responder.

A WLAN sensing session includes one or more of the following phases: session establishment, sensing measurement setup establishment, sensing measurement, sensing reporting, sensing measurement setup termination, or session termination.

Session establishment phase: establishing a sensing session, exchanging sensing capabilities of both parties and/or determining operating parameters related to sensing measurement, or declaring, by a terminal, its own role(s) and operating parameters (for example, by using a beacon frame or another special frame).

Sensing measurement setup establishment phase: determining sensing participants and their role (including one or more sensing signal transmitters and one or more sensing signal receivers), determining an operating parameters related to sensing measurement, and optionally exchanging the parameters between terminals.

Sensing measurement phase: implementing sensing measurement, where the one or more sensing signal transmitter transmit sensing signal(s) to the one or more sensing signal receiver.

Sensing reporting phase: reporting one or more measurement results, where depending on an application scenario, the one or more sensing signal receiver may need to report one or more measurement results to a sensing session initiator.

Sensing measurement setup termination phase: terminating one or more measurement setups, stopping corresponding measurement, and releasing related storage and computing resources.

Session termination phase: terminating all measurement setups, stopping measurement, and terminating a sensing session.

A data volume of a sensing measurement result is usually large, for example, a data volume of channel state information (CSI) of one measurement may reach 4 Kbit to 40 Kbit. A measurement threshold may be set to reduce a network load caused by reporting the sensing measurement result. When a variation between a current sensing measurement result and a previous sensing measurement result is more than the measurement threshold, a sensing signal receiver reports the sensing measurement result; otherwise, the sensing measurement result is not reported.

The sensing initiator may set a plurality of groups of measurement parameters. A group of measurement parameters (identified by a measurement setup ID, which may be equivalent to a burst group) may be applied to a plurality of measurements (each measurement is identified by a measurement instance ID, which may be equivalent to a burst).

In some embodiments, the sensing session initiator may set a plurality of groups of measurement parameters by using a measurement setup procedure. One measurement setup (Measurement Setup, or referred to as measurement configuration, Measurement Configuration) generally includes a group of measurement parameters, which may be identified by a measurement setup identity (Measurement Setup ID). One measurement setup may be applied to a plurality of measurements. One measurement (may be equivalent to a burst) may be considered as one measurement instance, and the measurement instance may be identified by a measurement instance identity (Measurement Instance ID).

In some embodiments, in order to reduce overheads of sensing measurement reporting and interference to another device, a trigger based (TB) measurement procedure may be executed, including three phases: a sensing measurement setup phase, a sensing measurement phase, and a sensing measurement reporting phase. In the sensing measurement setup phase, operating parameters, namely, a measurement setup, for implementing sensing measurement is mainly interacted or negotiated; in the sensing measurement phase, sensing measurement is mainly implemented based on the measurement setup; and in the sensing measurement device phase, one or more measurement results are mainly reported.

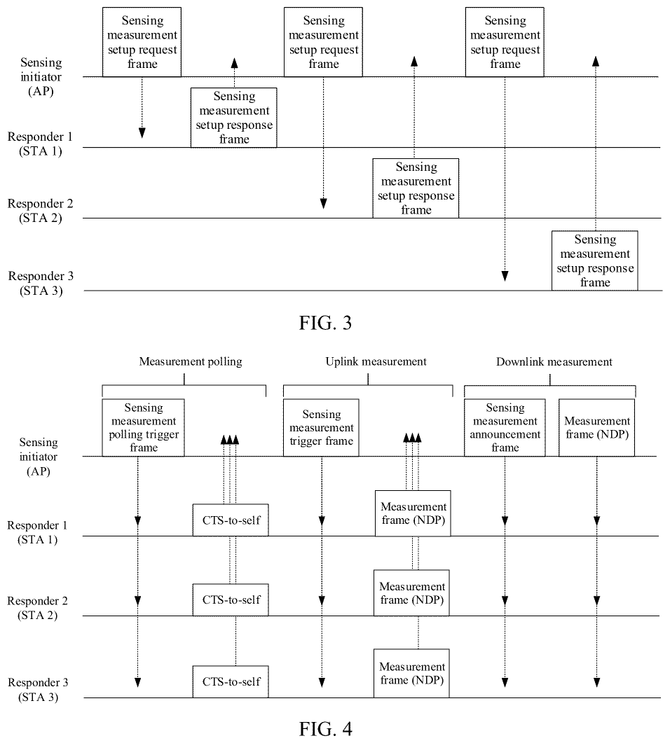

FIG. 3 is a schematic interaction diagram of a sensing measurement setup phase. As shown in FIG. 3, in the sensing measurement setup phase, the sensing initiator (for example, an AP device) and at least one sensing responder determine operating parameters, namely, a measurement setup, for implementing measurement by using a sensing measurement setup request frame and a sensing measurement setup response frame.

FIG. 4 is a schematic interaction diagram of a sensing measurement phase. As shown in FIG. 4, in the sensing measurement phase, a sensing initiator (for example, an AP device) determines, by using a sensing measurement polling trigger frame, the one or more sensing responders that perform measurement, further triggers, by using a sensing measurement trigger frame, the one or more sensing responders that perform measurement to transmit a measurement frame (for example, a null data physical layer protocol data unit (Null Data PPDU, NDP)) for uplink measurement, and notifies, through NDP announcement (NDPA), the one or more sensing responders to receive the measurement frame for downlink measurement.

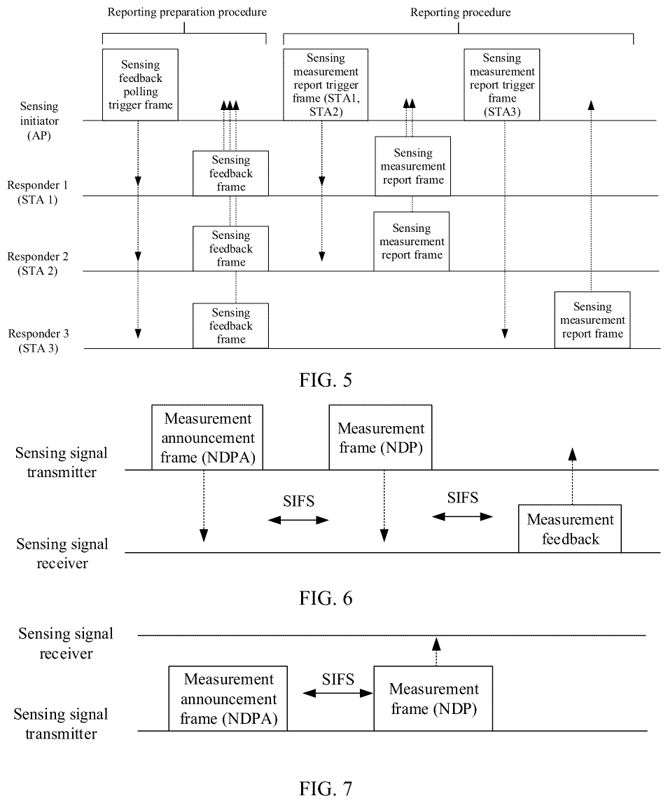

FIG. 5 is a schematic interaction diagram of a sensing reporting phase. As shown in FIG. 5, in the sensing reporting phase, a sensing initiator (for example, an AP device) determines, by using a sensing feedback polling trigger frame, the one or more sensing responders that perform measurement reporting. In response to the sensing feedback polling trigger frame, the one or more sensing responders may transmit a sensing feedback frame to an access point device. Further, the access point device triggers, by using sensing measurement report trigger frame, the one or more sensing responders that perform measurement reporting to transmit a sensing measurement report frame. The sensing feedback frame may be carried by using a TB physical layer protocol data unit (PPDU).

In some cases, when only one pair of devices is in sensing measurement, a non-trigger (non-TB) measurement procedure may be used.

In some scenarios, as shown in FIG. 6, the sensing initiator is a sensing signal transmitter. The sensing signal transmitter may transmit an NDPA frame to announce start of measurement, and after a short interframe space (SIFS) time, transmit an NDP frame. The sensing signal receiver receives the NDP frame to generate one or more measurement results. After the SIFS time, the sensing signal receiver reports the one or more measurement results to the sensing initiator.

In some other scenarios, the sensing initiator is a sensing signal receiver. As shown in FIG. 7, the sensing signal transmitter may transmit an NDPA frame to announce start of measurement, and after the SIFS time, transmit an NDP frame. The sensing signal receiver receives the NDP frame to generate one or more measurement results, and there is no need to report the one or more measurement results.

The sensing signal receiver may report the one or more measurement results in a manner of immediate report or delayed report. Optionally, the delayed report may be explicitly requested by the sensing initiator.

In some scenarios, introduction of sensing by proxy is considered, that is, a device (for example, a STA) may establish a sensing process by using another device (an AP) as a proxy. In this case, how a proxy device reports one or more sensing measurement results is an urgent problem to be solved.

To facilitate understanding of the technical solutions in embodiments of this application, the following describes the technical solutions in this application in detail by using specific embodiments. The foregoing related technologies, as optional solutions, may be randomly combined with the technical solutions of embodiments of this application, all of which fall within the protection scope of embodiments of this application. Embodiments of this application include at least a part of the following content.

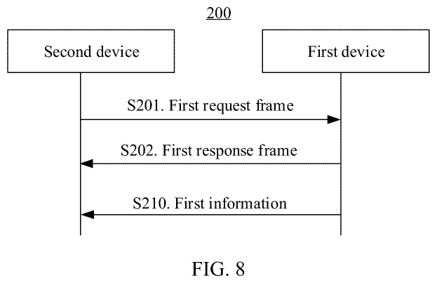

FIG. 8 is a schematic interaction diagram of a sensing reporting method 200 according to an embodiment of this application. As shown in FIG. 8, the method 200 includes the following contents.

S210: A first device transmits a first report frame to a second device, where the first report frame includes one or more measurement results of at least one sensing signal receiver of at least one measurement instance.

In the embodiment of this application, the first device is also referred to as a sensing by proxy device, or a sensing by proxy responder (Sensing by Proxy, SBP responder, or SBP responding STA). That is, the first device is a sensing proxy, or a sensing initiator supporting a proxy function (SBP capable Sensing Initiator).

In the embodiment of this application, the second device is also referred to as a sensing by proxy requester (SBP requester, or a SBP requesting STA). That is, the sensing by proxy requester may request the sensing by proxy device working as a proxy to establish a measurement setup or a sensing process.

In the embodiment of this application, the first report frame is also referred to as a sensing by proxy report frame (SBP Report), or a proxy report frame, or the like. A name of the frame is not limited in this application.

In some embodiments, the first device may be an AP, and the second device may be a Non-AP STA.

In some other embodiments, the first device and the second device may be different Non-AP STAs.

In some other embodiments, the first device and the second device may be different APs.

In some embodiments, the one or more measurement results of each measurement instance include the one or more measurement results of at least one sensing signal receiver.

In some embodiments, the one or more measurement results of each measurement instance may be all measurement results of the measurement instance, or may be some measurement results of the measurement instance.

In some embodiments, the at least one measurement instance corresponds to at least one measurement setup, and the at least one measurement setup is established by the first device working as a proxy of the second device. That is, the first device is a sensing initiator of the at least one measurement setup.

In some embodiments of this application, the method 200 further includes:
S201. receiving, by the first device, a first request frame transmitted by the second device, where the first request frame is used to request the first device working as a proxy to establish a measurement setup or a sensing process.

In some embodiments of this application, the method 200 further includes:
S202. transmitting, by the first device, a first response frame to the second device, where the first response frame is used to indicate whether the first device agrees to be a proxy of the second device to establish the measurement setup (or the sensing process), or in other words, whether the first device accepts a sensing by proxy request of the second device.

In some embodiments, the first request frame is also referred to as a sensing by proxy request frame (SBP request) or a proxy request frame, and the first response frame is also referred to as a sensing by proxy response frame (SBP response) or a proxy response frame, or the like. A name of the frame is not limited in this application.

In some embodiments, the first request frame includes requirement information (or referred to as sensing requirement information) of the sensing process requested by the second device to be established by a proxy.

By way of example rather than limitation, the sensing requirement information includes at least one of the following:
a quantity requirement of sensing responders, a frequency requirement of sensing measurements, a bandwidth requirement of sensing measurements, a type of sensing measurement (such as trigger based sensing measurement or non-trigger based sensing measurement), and a manner in which a sensing by proxy device reports measurement results (or referred to as sensing results or sensing measurement results) to a sensing by proxy requester.

In some embodiments, the frequency information of sensing measurement may refer to a quantity of times sensing measurement is performed in a unit time, and the unit time may be 1 second, or 100 milliseconds, or the like, which is not limited in this application.

In some embodiments, the sensing requirement information may include scheduling information of a measurement setup, which is used for scheduling between a plurality of sensing by proxy devices when a sensing by proxy requester establishes a same measurement setup by using the plurality of sensing by proxy devices working as proxies.

In some embodiments, the scheduling information of the measurement setups includes measurement start time information and time interval information of measurement instances.

In some embodiments, the measurement start time information may refer to a start time of the first measurement instance of the measurement setup. For example, the measurement start time information may be a partial timing synchronization function (partial TSF) value of a target time, or a value of offset between a target time and a current time. The partial TSF may represent truncated data of a synchronization time value, for example, removing the most significant 38 bits and the least significant 10 bits from 64 bits of a TSF timer.

In some embodiments, the time interval information of measurement instances may refer to a time interval between two measurement instances that are adjacent in a time sequence of the measurement setup.

In some embodiments, a manner in which a sensing by proxy device reports one or more measurement results to a sensing by proxy requester include but is not limited to at least one of the following:
a first reporting manner, used to indicate that a measurement result is reported in a case when a measurement result reported by a sensing signal receiver is received;
a second reporting manner, used to indicate that, after a measurement instance ends, the one or more measurement results received in the measurement instance or before a succeeding measurement instance are reported; and
a third reporting manner, used to indicate that, after all measurement results of each measurement instance in N measurement instances are obtained, all measurement results of each measurement instance in the N measurement instances are reported, where N is a positive integer.

In some embodiments, N is predefined, for example, N is 1, or 2, or the like.

In some other embodiments, N is indicated by the second device, for example, the second device may indicate N in the first request frame.

In some embodiments of this application, one measurement instance may correspond to one measurement setup, and the measurement instance may be a measurement performed based on the measurement setup. Optionally, a quantity of measurement instances corresponding to one measurement setup may be one or more, that is, one or more measurement instances may be implemented based on one measurement setup. In other words, one measurement setup may correspond to one or more measurement instances.

In some other embodiments of this application, one measurement instance may alternatively correspond to a plurality of measurement setups, that is, one measurement instance may be implemented based on a plurality of measurement setups. In this case, it may be considered that the plurality of measurement setups share one measurement instance. A correspondence between a measurement instance and a measurement setup is not limited in this application.

It should be understood that in embodiments of this application, the at least one measurement instance may correspond to one measurement setup, or may correspond to a plurality of measurement setups. That is, the sensing by proxy device may report one or more measurement results of a measurement instance corresponding to one measurement setup at a time, or may report one or more measurement results of a measurement instance corresponding to a plurality of measurement setups.

In some embodiments of this application, the at least one measurement instance may be a trigger based (TB) measurement instance, or may be a non-trigger based (non-TB) measurement instance.

In some embodiments of this application, the method 200 further includes:
receiving, by the first device, one or more measurement results of the at least one measurement instance transmitted by the sensing signal receiver.

It should be understood that, a specific quantity of sensing signal receivers that report one or more measurement results and a specific manner in which a sensing signal receiver reports the one or more measurement results to the first device is not limited in embodiments of this application. For example, reporting of the one or more measurement results by a sensing signal receiver may be based on trigger of the first device, or may be non-trigger reporting. For another example, reporting of the one or more measurement results by a sensing signal receiver may be immediate reporting or delayed reporting.

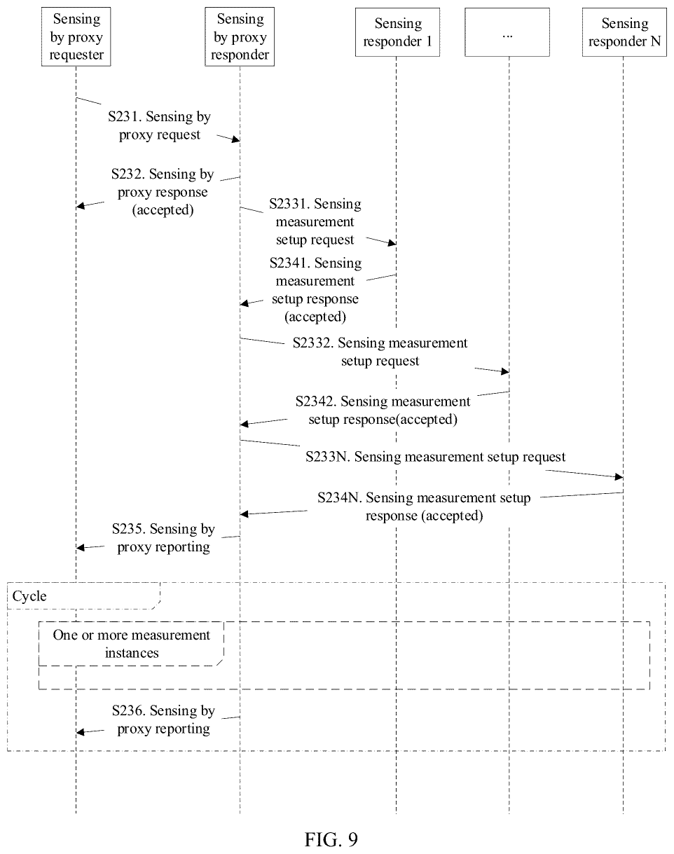

With reference to FIG. 9, from a perspective of interaction between a sensing by proxy requester, a sensing by proxy responder and one or more sensing responders, an overall flowchart of successful sensing by proxy according to an embodiment of this application is described. As shown in FIG. 9, at least some of the following steps may be included.

S231. A sensing by proxy requester transmits a sensing by proxy request to a sensing by proxy responder, where the sensing by proxy request corresponds to the foregoing first request frame, and is used to request the sensing by proxy responder working as a proxy to establish a sensing process or a measurement setup.

Optionally, the sensing by proxy request includes sensing requirement information of the sensing by proxy requester. For specific content, refer to relevant description in foregoing embodiments. Details are not described herein again.

S232. The sensing by proxy responder transmits a sensing by proxy response to the sensing by proxy requester, where the sensing by proxy response corresponds to the foregoing first response frame, and is used to indicate whether the sensing by proxy responder accepts the sensing by proxy request of the sensing by proxy requester. In this example, the sensing by proxy responder accepts the sensing by proxy request of the sensing by proxy requester.

Optionally, the sensing by proxy responder generates measurement setup information based on the sensing requirement information carried in the sensing by proxy request.

In some embodiments, the measurement setup information includes at least one of the following:
a measurement setup identity, frequency information of sensing measurement, quantity information of sensing responders, one or more IDs of one or more sensing responders, one or more manners in which one or more sensing signal receivers report one or more measurement results to a sensing by proxy device, and information about role(s) of one or more sensing responders in sensing measurement(s).

Further, the sensing by proxy responder may transmit a sensing measurement setup request to at least one sensing responder, where the sensing measurement setup request includes a measurement setup requested to be established.

It should be understood that a specific quantity of sensing responders is not limited in this application, for example, there may be one or more sensing responders.

In an example, in S2331 to S233N, the sensing by proxy responder may transmit the sensing measurement setup request to N sensing responders.

Further, the sensing by proxy responder receives a sensing measurement setup response transmitted by the at least one sensing responder, where the sensing measurement setup response is used to indicate whether the sensing responder accepts a measurement setup requested to be established in the sensing measurement setup request.

In an example, in S2341 to S234N, the N sensing responders each transmit a sensing measurement setup response to the sensing by proxy responder, where the sensing measurement setup response is used to indicate that the corresponding sensing responder accepts a measurement setup requested to be established in the sensing measurement setup.

S235. The sensing by proxy responder transmits a sensing by proxy report frame to the sensing by proxy requester, where the sensing by proxy report frame is used to indicate an establishment result of a measurement setup established by a proxy, for example, whether establishment is successful, or a cause of an establishment failure.

Further, in a case in which the measurement setup is successfully established, subsequent measurement and a report process may be performed, based on the successfully established measurement setup, between the sensing by proxy responder and one or more sensing responders that agree to the measurement setup.

For example, the sensing by proxy device may receive a measurement result of at least one sensing signal receiver of at least one measurement instance transmitted by the sensing responder. Further, in S236, the sensing by proxy device transmits a sensing by proxy report frame to the sensing by proxy requester to report the measurement result of the at least one sensing signal receiver of the at least one measurement instance.

In some embodiments of this application, a measurement setup identity space (Measurement Setup ID space) may be divided into a first measurement setup identity space and a second measurement setup identity space, which are respectively used to identify a measurement setup corresponding to a measurement setup established according to a proxy request and a measurement setup corresponding to a measurement setup established not according to a proxy request. The first measurement setup identity space and the second measurement setup identity space are different from each other, which is conducive to simplifying implementation and quick search.

For example, a measurement setup identity carried in the sensing measurement setup request frame may belong to the first measurement setup identity space.

By way of example rather than limitation, the measurement setup identity space includes integer values from 0 to 31, the first measurement setup identity space includes integer values from 16 to 31, and the second measurement setup identity space includes integer values from 0 to 15.

It should be understood that the measurement setup identity space, and the division manner of the first measurement setup identity space and the second measurement setup identity space are only examples. The measurement setup identity space may alternatively be another value range, and the first measurement setup identity space and the second measurement setup identity space may alternatively use another division manner, as long as the first measurement setup identity space and the second measurement setup identity space do not overlap, which is not limited in this application.

In some embodiments, the sensing by proxy device may record information (including but not limited to the information in following tables) about a measurement setup to be established in two tables depending on whether the measurement setup is established according to a sensing by proxy request, as shown in Table 1 and Table 2 below. Table 1 is used to record information about a measurement setup established according to a proxy request. Table 2 is used to record information about a measurement setup established not according to a proxy request.

TABLE 1

| Sensing by | | | | Sensing | |
|---|---|---|---|---|---|
| proxy | Measurement | Sensing signal | Sensing signal | procedure | Sensing |
| requester ID | setup ID | transmitter ID | receiver ID | type | result type |
| 1 | 16 | 0, 2, 3, 4 | 0, 2, 5 | 0 | 0 |
| 1 | 17 | 0 | 6 | 0 | 0 |
| 4 | 18 | 0 | 5 | 1 | 0 |

TABLE 2

| | Sensing | | | |
|---|---|---|---|---|
| | signal | Sensing | Sensing | Sensing |
| Measurement | transmitter | signal | procedure | result |
| setup ID | ID | receiver ID | type | type |
| 0 | 3, 100 | 0, 5, 100 | 0 | 0 |
| 1 | 0/7 | 0/7 | 1 | 0 |

As shown in Table 1, a sensing by proxy requester 1 (an associated device, for example, a device ID is AID, and its value is 1) requests a sensing by proxy device 0 (an AID value is 0) to establish two measurement setups, a value of the measurement setup ID for one measurement setup is 16, and a value of the measurement setup ID for the other measurement setup is 17. Both use a trigger based measurement procedure (for example, a value of the sensing procedure type is 0). A sensing by proxy requester 4 (an AID value is 4) requests the sensing by proxy device 0 (the AID value is 0) to establish a measurement setup, a value of the measurement setup ID is 18, which uses a non-trigger based measurement procedure (for example, a value of the sensing procedure type is 1). The sensing result types of the three measurement setups are all CSI (indicated by a type value 0).

In the measurement setup 16, a device 0 and a device 2 are both sensing signal transmitters and sensing signal receivers, a device 3 is only a sensing signal transmitter, and a device 5 is only a sensing signal receiver.

In the measurement setup 17, the device 0 is only a sensing signal transmitter, and a device 6 is only a sensing signal receiver.

In the measurement setup 18, the device 0 is only a sensing signal transmitter, and the device 5 is only a sensing signal receiver.

As shown in Table 2, the sensing by proxy device 0 establishes two measurement setups that use no proxy, a value of the measurement setup ID for one measurement setup is 0, and a value of the measurement setup ID for the other measurement setup is 1. The two procedures are respectively a trigger based measurement procedure (for example, a value of the sensing procedure type is 0) and a non-trigger based measurement procedure (for example, a value of the sensing procedure type is 1). The sensing result types of the two measurement setups are both CSI (indicated by a type value 0).

In the measurement setup 0, a device 100 is both a sensing signal transmitter and a sensing signal receiver, the device 3 is only a sensing signal transmitter, and the device 5 is only a sensing signal receiver.

In the measurement setup 1, the device 0 and a device 7 are both sensing signal transmitters and sensing signal receivers.

It should be noted that, a manner and/or frequency that the sensing by proxy device reports one or more measurement results to the sensing by proxy requester is not limited in this application. For example, a reporting manner may include but is not limited to immediate report (for example, reporting immediately upon receiving a measurement result, that is, a time interval between receiving the measurement result and reporting the measurement result is a SIFS), and delayed report (for example, a time interval between receiving the measurement result and reporting the measurement result is greater than the SIFS). For another example, the measurement result may be reported in a unit of a measurement instance, or reported by using a specific time node (for example, after a measurement instance ends, or before a measurement instance starts) as a reference, or reported each time a measurement result transmitted by the sensing signal receiver is received.

In embodiments of this application, the reporting manner of a measurement result includes at least one of the following:
a first reporting manner, used to indicate that a measurement result is reported in a case when a measurement result reported by a sensing signal receiver is received;
a second reporting manner, used to indicate that, after a measurement instance ends, the one or more measurement results received in the measurement instance or before a succeeding measurement instance are reported; and
a third reporting manner, used to indicate that, after all measurement results of each measurement instance in N measurement instances are obtained, all measurement results of each measurement instance in the N measurement instances are reported, where N is a positive integer.

In some embodiments, the manner in which the sensing by proxy device reports one or more measurement results to the sensing by proxy requester may be predefined, for example, the first reporting manner, or the second reporting manner, or the third reporting manner may be predefined to report the one or more measurement result.

In some other embodiments, the manner in which the sensing by proxy device reports one or more measurement results to the sensing by proxy requester may be indicated by the sensing by proxy requester.

For example, the sensing by proxy requester may carry first indication information in the first request frame, and the first indication information is used to indicate a target reporting manner in which the sensing by proxy device reports the one or more measurement results.

The following describes the manner in which the sensing by proxy device reports one or more measurement results to the sensing by proxy requester with reference to specific embodiments, but this application is not limited thereto.

### Embodiment 1: The First Reporting Manner (or Referred to as Immediate Report, Immediate Forwarding)

In some embodiments of this application, S210 may include:
transmitting, by the first device, the first report frame to the second device in a case of receiving the one or more measurement results of the at least one sensing signal receiver, where the first report frame includes the one or more measurement results of the at least one sensing signal receiver.

That is, each time the first device receives one or more measurement results from a sensing signal receiver, the first device reports the received measurement result to the second device. By reporting the measurement result in this manner, the sensing by proxy device may refresh cache in time, which can reduce the cache to the greatest extent.

Optionally, that each time the first device receives one or more measurement results from a sensing signal receiver, the first device reports the received measurement result to the second device may include:
after a SIFS time following reception of the one or more measurement results of the sensing signal receiver, the first device reports the received measurement result to the second device, that is, a time interval between receiving the measurement result and reporting the measurement result may be a SIFS.

In some embodiments, the measurement result of the at least one sensing signal receiver may include some measurement results of one measurement instance, or may include all measurement results of one measurement instance.

In some embodiments, the measurement result of the at least one sensing signal receiver may be received in the measurement instance, or may be received after the measurement instance. That is, a sensing signal receiver may report a measurement result in the measurement instance, or may report the measurement result after the measurement instance.

In some embodiments, the measurement result of the at least one sensing signal receiver is received in a first TXOP, and the first TXOP is used to implement a second measurement instance. The measurement result of the at least one sensing signal receiver includes a measurement result of the second measurement instance and/or a measurement result of the first measurement instance, where the first measurement instance is a previous measurement instance of the second measurement instance. That is, the measurement result received in the second measurement instance may include a measurement result of the second measurement instance (for example, for a scenario of immediate report), or may include a measurement result of a previous measurement instance (for example, for a scenario of delayed report).

In some embodiments, the first measurement instance being a previous measurement instance of the second measurement instance may refer to that:
the first measurement instance and the second measurement instance are adjacent in a time sequence, and the first measurement instance is earlier than the second measurement instance.

In some embodiments, the first measurement instance and the second measurement instance correspond to a same measurement setup, or may correspond to different measurement setups. That is, two measurement instances that are adjacent in a time sequence may be implemented based on a same measurement setup, or may be implemented based on different measurement setups.

In some embodiments, the first device may transmit the first report frame in a first TXOP or a second TXOP, and the second TXOP is a TXOP obtained after the first TXOP.

In other words, the first device may transmit the first report frame in the measurement instance or after the measurement instance.

The first reporting manner is described below with reference to specific examples.

### Example 1

In Example 1, the measurement result of the at least one sensing signal receiver includes some measurement results of one measurement instance (noted as a measurement instance 1), that is, the measurement results of one measurement instance may be triggered and reported in a plurality of times. In addition, the measurement instance 1 is a trigger based measurement instance, and all of the at least one sensing signal receiver supports immediate report.

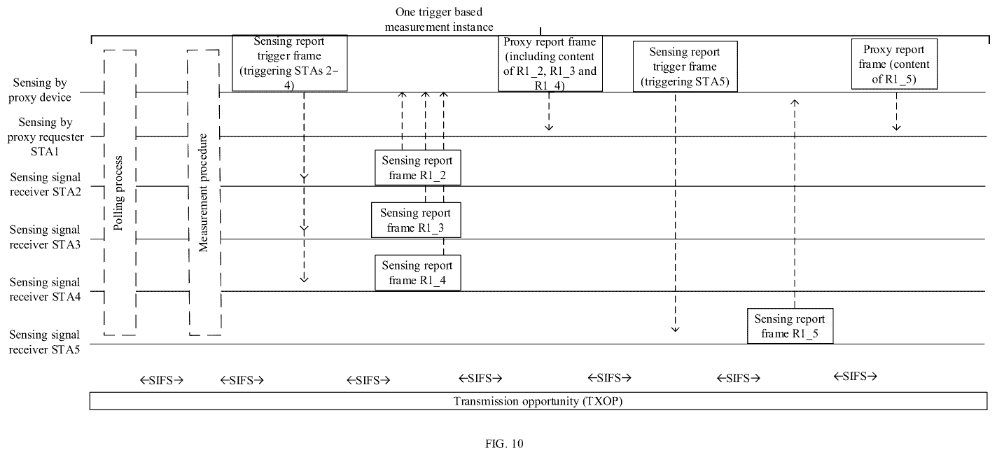

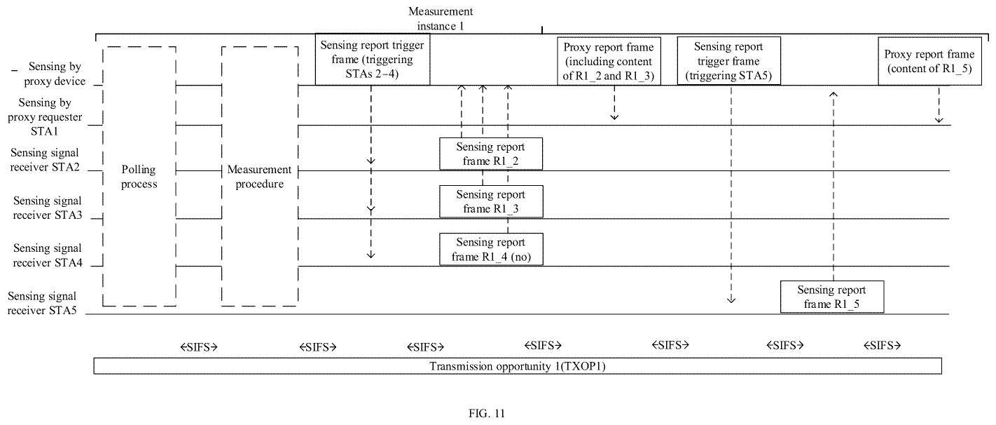

As shown in FIG. 10, the sensing by proxy requester is a STA1, and the sensing signal receivers include a STA2 to a STA5. The STA2 to STA5 all support immediate report. After a polling process and a measurement process, the sensing by proxy device may trigger the sensing signal receivers to report measurement results.

In Example 1, the sensing by proxy device triggers, at one time, some sensing signal receivers to report measurement results. For example, orthogonal frequency division multiple access time-frequency resource units (OFDMA RUs) for reporting measurement results are insufficient, or some sensing signal receivers require a relatively long processing time to generate the measurement results.

For example, as shown in FIG. 10, the sensing by proxy device first triggers the STA2, STA3 and STA4 to report measurement results. The STA2, STA3 and STA4 support immediate report, and thus after receiving a sensing report trigger frame of the sensing by proxy device, each of the STA2, STA3 and STA4 immediately transmits a sensing report frame to the sensing by proxy device, for example, transmits a sensing report frame after a SIFS time following reception of the sensing report trigger frame.

Specifically, the STA2 transmits a sensing report frame R1_2, the STA3 transmits a sensing report frame R1_3, and the STA4 transmits a sensing report frame R1_4. The sensing report frame R1_2, the sensing report frame R1_3, and the sensing report frame R1_4 respectively include measurement results of the STA2, STA3, and STA4 in the measurement instance 1.

After receiving the sensing report frames transmitted by the STA2, STA3 and STA4, the sensing by proxy device may transmit a proxy report frame to the sensing by proxy device, and the proxy report frame includes the measurement results included in the sensing report frame R1_2, the sensing report frame R1_3, and the sensing report frame R1_4.

Further, the sensing by proxy device triggers a STA5 to report a measurement result. The STA5 supports immediate report, and thus after receiving a sensing report trigger frame of the sensing by proxy device, the STA5 immediately transmits a sensing report frame to the sensing by proxy device, that is, transmits a sensing report frame R1_5 after a SIFS time following reception of the sensing report trigger frame, where the sensing report frame 1_5 includes a measurement result of the STA5 in the measurement instance 1. After receiving the sensing report frame of the STA5, the sensing by proxy device transmits a proxy report frame to the sensing by proxy device, where the proxy report frame includes the measurement result included in the sensing report frame R1_5.

In Example 1, the proxy report frame is reported in the measurement instance 1. That is, the sensing by proxy device performs transmission by using a TXOP corresponding to the measurement instance 1.

### Example 2

In Example 2, the measurement result of the at least one sensing signal receiver includes some measurement results of one measurement instance (noted as a measurement instance 1), and the measurement instance 1 is a trigger based measurement instance. There is a sensing signal receiver, in the at least one sensing signal receiver, that does not support immediate report (or supports delayed report).

Different from Example 1, in this measurement instance 1, the sensing signal receiver that does not support immediate report may report a measurement result of a previous measurement instance. In particular, if the measurement instance 1 is the first measurement instance, the sensing signal receiver that does not support immediate report may not be triggered, or a sensing report frame transmitted by the sensing signal receiver does not include a measurement result, or includes invalid result data.

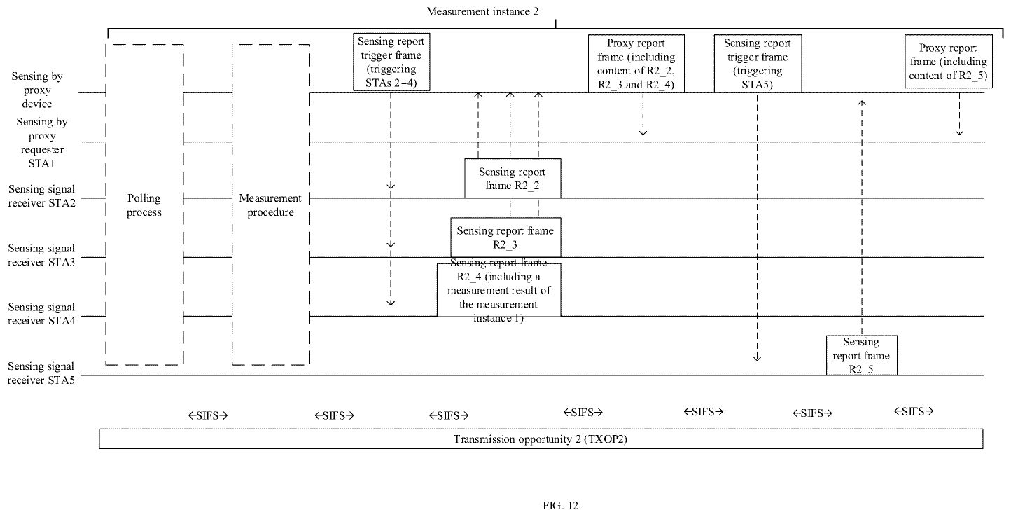

With reference to FIG. 11 and FIG. 12, two measurement instances, namely, a measurement instance 1 and a measurement instance 2, that are adjacent in a time sequence are used as an example to illustrate a specific reporting manner, where the measurement instance 1 is the first measurement instance.

As shown in FIG. 11 and FIG. 12, the sensing by proxy requester is a STA1, and the sensing signal receivers include a STA2 to a STA5, where the STA2, STA3 and STA5 support immediate report, and the STA4 does not support immediate report.

As shown in FIG. 11, in the measurement instance 1, after the sensing by proxy device triggers the STA2, STA3 and STA4 to report measurement results, the STA2 transmits a sensing report frame R1_2, the STA3 transmits a sensing report frame R1_3, and the STA4 transmits a sensing report frame R1_4. The sensing report frame R1_2 and the sensing report frame R1_3 include measurement results of the measurement instance 1. The sensing report frame R1_4 does not include a measurement result, or includes invalid result data. After receiving the sensing report frames of the STA2, STA3 and STA4, the sensing by proxy device may transmit a proxy report frame to the sensing by proxy device, where the proxy report frame includes the measurement results included in the sensing report frame R1_2 and the sensing report frame R1_3.

Further, the sensing by proxy device triggers the STA5 to report a measurement result. If the STA5 supports immediate report, the STA5 transmits a sensing report frame R1_5, where the sensing report frame 1_5 includes the measurement result of the STA5 in the measurement instance 1. After receiving the sensing report frame of the STA5, the sensing by proxy device may transmit a proxy report frame to the sensing by proxy device, where the proxy report frame includes the measurement result included in the sensing report frame R1_5.

As shown in FIG. 12, in the measurement instance 2 (namely, a succeeding measurement instance of the measurement instance 1), the sensing by proxy device first triggers the STA2, STA3 and STA4 to report measurement results. Further, the STA2 transmits a sensing report frame R2_2, the STA3 transmits a sensing report frame R2_3, and the STA4 transmits a sensing report frame R2_4. The sensing report frame R2_2 and the sensing report frame R2_3 include measurement results of the measurement instance 2. The sensing report frame R2_4 includes a measurement result of the measurement instance 1. After receiving the sensing report frames of the STA2, STA3 and STA4, the sensing by proxy device may transmit a proxy report frame to the sensing by proxy device, and the proxy report frame includes the measurement results included in the sensing report frame R2_2, the sensing report frame R2_3, and the sensing report frame 2_4.

Then, the sensing by proxy device triggers the STA5 to report a measurement result. If the STA5 supports immediate report, the STA5 transmits a sensing report frame R2_5, where the sensing report frame 2_5 includes the measurement result of the STA5 in the measurement instance 2. After receiving the sensing report frame of the STA5, the sensing by proxy device may transmit a proxy report frame to the sensing by proxy device, where the proxy report frame includes the measurement result included in the sensing report frame R2_5.

### Example 3

In Example 3, the measurement result of the at least one sensing signal receiver includes some measurement results of a measurement instance (noted as a measurement instance 1), and the measurement instance 1 is a trigger based measurement instance. There is a sensing signal receiver, in the at least one sensing signal receiver, that does not support immediate report (or supports delayed report).

Different from Example 2, since the sensing signal receiver that does not support immediate report requires a relatively long processing time to generate a measurement result, the sensing by proxy device triggers, after the measurement instance, the sensing signal receiver to report the measurement result.

As shown in FIG. 13, the sensing by proxy requester is a STA1, and the sensing signal receivers include a STA2 to a STA5, where the STA2, STA3 and STA4 support immediate report, and the STA5 does not support immediate report.

As shown in FIG. 13, after the measurement instance 1, the sensing by proxy device contends for a channel again to obtain a TXOP, and transmits a sensing report trigger frame to trigger the STA5 to report a measurement result. The STA5 transmits a sensing report frame R1_5, where the sensing report frame 1_5 includes the measurement result of the STA5 in the measurement instance 1. After receiving the sensing report frame of the STA5, the sensing by proxy device may transmit a proxy report frame to the sensing by proxy device, where the proxy report frame includes the measurement result included in the sensing report frame R1_5.

### Example 4

In Example 4, the measurement result of the at least one sensing signal receiver includes all measurement results of a measurement instance (noted as a measurement instance 1), and the measurement instance 1 is a trigger based measurement instance.

Different from Example 1, the sensing by proxy device triggers, at one time, all sensing signal receivers to report measurement results.

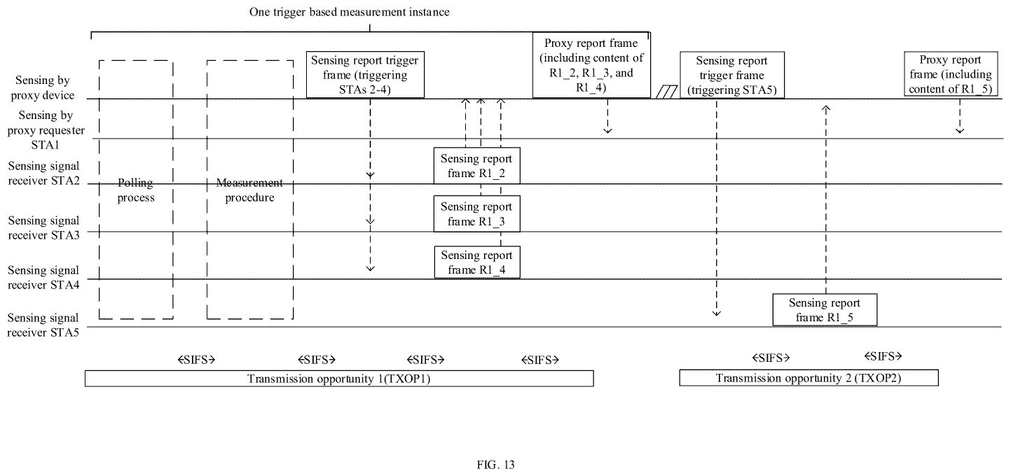

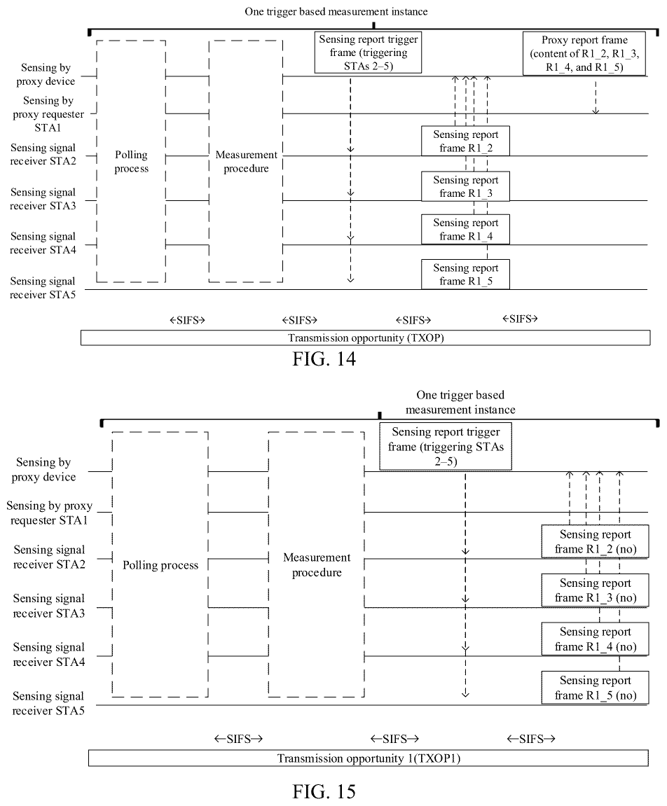

As shown in FIG. 14, the sensing by proxy requester is a STA1, and the sensing signal receivers include a STA2 to a STA5, all of which support immediate report.

After the sensing by proxy device triggers the STA2 to STA5 to report measurement results, the STA2 transmits a sensing report frame R1_2, the STA3 transmits a sensing report frame R1_3, and the STA4 transmits a sensing report frame R1_4, and the STA5 transmits a sensing report frame R1_5, all of which include measurement results of the measurement instance 1. After receiving the foregoing sensing report frames, the sensing by proxy device transmits a proxy report frame to the sensing by proxy device, and the proxy report frame includes measurement results included in the sensing report frame R1_2, the sensing report frame R1_3, the sensing report frame R1_4, and the sensing report frame R1_5.

### Example 5

In Example 5, the measurement result of the at least one sensing signal receiver includes all measurement results of one measurement instance, and the measurement instance is a trigger based measurement instance. None of the at least one sensing signal receiver supports immediate report.

In Example 5, in one measurement instance, a sensing signal receiver that does not support immediate report may report a measurement result of a previous measurement instance. In particular, in the first measurement instance 1 (noted as a measurement instance 1), the sensing signal receiver that does not support immediate report may not be triggered, or a sensing report frame transmitted by the sensing signal receiver does not include a measurement result, or includes invalid result data.

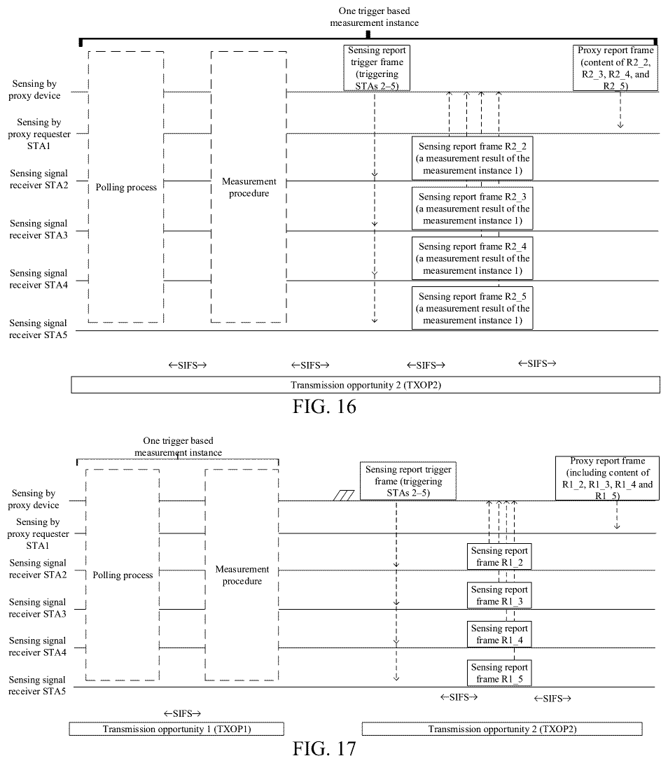

With reference to FIG. 15 and FIG. 16, two measurement instances, namely, a measurement instance 1 and a measurement instance 2, that are adjacent in a time sequence are used as an example to illustrate a specific reporting manner, where the measurement instance 1 is the first measurement instance.

As shown in FIG. 15 and FIG. 16, the sensing by proxy requester is a STA1, and the sensing signal receivers include a STA2 to a STA5, none of which support immediate report.

As shown in FIG. 15, in the measurement instance 1, the sensing by proxy device triggers the STA2 to STA5 to report measurement results, the STA2 transmits a sensing report frame R1_2, the STA3 transmits a sensing report frame R1_3, the STA4 transmits a sensing report frame R1_4, and the STA5 transmits a sensing report frame R1_5. None of the foregoing sensing report frames includes a measurement result, or includes invalid result data. After receiving the foregoing sensing report frames, the sensing by proxy device may not transmit a proxy report frame to the sensing by proxy device.

As shown in FIG. 16, in the measurement instance 2 (namely, a succeeding measurement instance of the measurement instance 1), the sensing by proxy device triggers the STA2 to STA5 to report measurement results. Further, the STA2 transmits a sensing report frame R2_2, the STA3 transmits a sensing report frame R2_3, and the STA4 transmits a sensing report frame R2_4, and the STA5 transmits a sensing report frame R2_5. The foregoing sensing report frames all include the measurement results of the measurement instance 1. After receiving the foregoing sensing report frames, the sensing by proxy device may transmit a proxy report frame to the sensing by proxy device, and the proxy report frame includes measurement results included in the sensing report frame R2_2, the sensing report frame R2_3, the sensing report frame R2_4, and the sensing report frame R2_5.

In Example 5, the measurement results of the measurement instance 1 may be reported by using a TXOP corresponding to the measurement instance 2 (namely, a TXOP 2).

### Example 6

In Example 6, the measurement result of the at least one sensing signal receiver includes all measurement results of one measurement instance, and the measurement instance is a trigger based measurement instance. None of the at least one sensing signal receiver supports immediate report.

Different from Example 5, since the sensing signal receiver that does not support immediate report requires a relatively long processing time to generate a measurement result, the sensing by proxy device triggers, after the measurement instance, the sensing signal receiver to report the measurement result.

As shown in FIG. 17, the sensing by proxy requester is a STA1, and the sensing signal receivers include a STA2 to a STA5, none of which supports immediate report.

As shown in FIG. 17, after a measurement instance 1, the sensing by proxy device contends for a channel again to obtain a TXOP, and transmits a sensing report trigger frame to trigger the STA2 to STA5 to report measurement results. Further, the STA2 transmits a sensing report frame R1_2, the STA3 transmits a sensing report frame R1_3, the STA4 transmits a sensing report frame R1_4, and the STA5 transmits a sensing report frame R1_5. The foregoing sensing report frames all include the measurement results of the measurement instance 1. After receiving the foregoing sensing report frames, the sensing by proxy device may transmit a proxy report frame to the sensing by proxy device, and the proxy report frame includes measurement results included in the sensing report frame R1_2, the sensing report frame R1_3, the sensing report frame R1_4, and the sensing report frame R1_5.

### Example 7

In Example 7, a measurement instance is a non-trigger based measurement instance, and a sensing signal receiver supports immediate report.

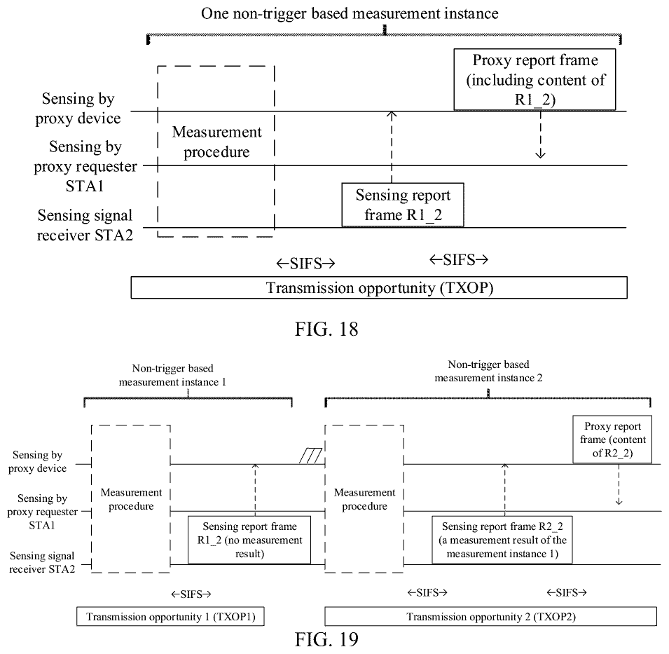

As shown in FIG. 18, in a non-trigger based measurement instance, the sensing by proxy requester is a STA1, sensing participants include the sensing by proxy device and a sensing signal receiver STA2, and the STA2 supports immediate report. The sensing signal receiver STA2 immediately transmits a sensing report frame R1_2 after a measurement process is completed. The sensing device frame R1_2 includes a measurement result of the present measurement instance. After receiving the sensing report frame, the sensing by proxy device may transmit a proxy report frame to the sensing by proxy device, where the proxy report frame includes the measurement result included in the sensing report frame R1_2.

### Example 8

In Example 8, a measurement instance is a non-trigger based measurement instance, and a sensing signal receiver does not support immediate report.

In a non-trigger based measurement instance, the sensing by proxy requester is a STA1, sensing participants include the sensing by proxy device and a sensing signal receiver STA2, and the STA2 does not support immediate report.

Two measurement instances, namely, a measurement instance 1 and a measurement instance 2, that are adjacent in a time sequence are used as an example to illustrate a specific reporting manner, where the measurement instance 1 is the first measurement instance.

As shown in FIG. 19, in the measurement instance 1, the sensing signal receiver STA2 transmits a sensing report frame R1_2 after a measurement process is completed. The sensing device frame R1_2 does not include a measurement result, or includes invalid result data. After receiving the sensing report frame R1_2, the sensing by proxy device does not transmit a proxy report frame to the sensing by proxy device.

In the measurement instance 2, the sensing signal receiver STA2 transmits a sensing report frame R2_2 after a measurement process is completed. The sensing device frame R2_2 includes a measurement result of the measurement instance 1. After receiving the sensing report frame R2_2, the sensing by proxy device transmits a proxy report frame to the sensing by proxy device, where the proxy report frame includes the measurement result included in the sensing report frame R2_2.

### Example 9

In Example 9, a measurement instance is a non-trigger based measurement instance, and a sensing signal receiver does not support immediate report.

Different from Example 8, since the sensing signal receiver that does not support immediate report requires a relatively long processing time to generate a measurement result, the sensing signal receiver reports the measurement result after the measurement instance.

In a non-trigger based measurement instance, the sensing by proxy requester is a STA1, sensing participants include the sensing by proxy device and a sensing signal receiver STA2, and the STA2 does not support immediate report.

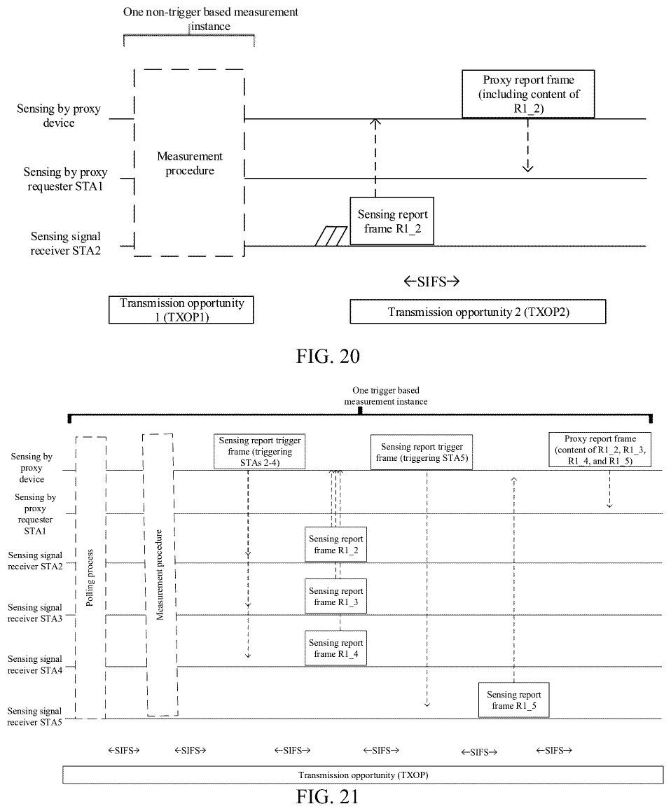

As shown in FIG. 20, after a measurement process is completed, the sensing signal receiver STA2 contends for a channel again to obtain a TXOP 2, and then uses the TXOP 2 to transmit a sensing report frame R1_2. The sensing device frame R1_2 includes the measurement result of the present measurement instance. After receiving the sensing report frame R1_2, the sensing by proxy device transmits a proxy report frame to the sensing by proxy device, where the proxy report frame includes the measurement result included in the sensing report frame R1_2.

### Embodiment 2: The Second Reporting Manner (or Referred to as Reporting after a Measurement Instance, that is, Forwarding after Each Instance)

In some other embodiments of this application, S210 may include:
transmitting, by the first device, a first report frame to the second device after each measurement instance, where the first report frame includes one or more measurement results received in the measurement instance or before a succeeding measurement instance.

That is to say, in embodiments of this application, the sensing by proxy device may report one or more measurement results by using end of a measurement instance or start of a measurement instance as a time node. This reporting manner can reduce caches of the sensing by proxy device to some extent, and can also reduce power consumption of a device by enabling the sensing by proxy requester more in an idle or doze state.

In the second reporting manner, the sensing by proxy device may report at one time one or more measurement results received in one measurement instance (in other words, one or more measurement results received before one measurement instance ends), or one or more measurement results received before a succeeding measurement instance starts.

In some embodiments, the one or more measurement results received by the sensing by proxy device in one measurement instance may include one or more measurement results of the present measurement instance and/or one or more measurement results of a previous measurement instance.

For example, in a scenario of immediate report, the one or more measurement results received by the sensing by proxy device in one measurement instance may include the one or more measurement results of the present measurement instance.

For another example, in a scenario of delayed report, the one or more measurement results received by the sensing by proxy device in one measurement instance may include the one or more measurement results of the previous measurement instance.

In some embodiments, the one or more measurement results received by the sensing by proxy device before a succeeding measurement instance may include one or more measurement results of the present measurement instance and/or one or more measurement results of a previous measurement instance.

For example, in a scenario of immediate report, the one or more measurement results received by the sensing by proxy device before a succeeding measurement instance may include the one or more measurement results of the present measurement instance.

For another example, in a scenario of delayed report, the one or more measurements result received by the sensing by proxy device before a succeeding measurement instance may include the measurement result of the previous measurement instance, or may include the one or more measurement results of the present measurement instance.

It should be understood that, in embodiments of this application, a previous measurement instance and a succeeding measurement instance are relative to a present measurement instance (or a current measurement instance). The previous measurement instance, the present measurement instance, and the succeeding measurement instance may refer to three measurement instances that are adjacent in a time sequence, and may correspond to a same measurement setup or different measurement setups.

In some embodiments, the at least one measurement instance includes a fourth measurement instance, a succeeding measurement instance of the fourth measurement instance is a fifth measurement instance, and a previous measurement instance of the fourth measurement instance is a third measurement instance. A measurement result received in the fourth measurement instance includes a measurement result of the fourth measurement instance and/or a measurement result of the third measurement instance, and a measurement result received before the fifth measurement instance includes the measurement result of the fourth measurement instance and/or the measurement result of the third measurement instance.

In some embodiments, the transmitting, by the first device, a first report frame to the second device after each measurement instance includes:
transmitting the first report frame to the second device based on a TXOP corresponding to the measurement instance; or
transmitting the first report frame to the second device based on a TXOP obtained after the measurement instance.

For example, the at least one measurement instance includes a fourth measurement instance, and the fourth measurement instance is measured based on a TXOP 4. The measurement result received in the fourth measurement instance may be reported by using the TXOP 4, or may be reported by using a TXOP 5, where the TXOP 5 is a TXOP obtained by contending for a channel again after the TXOP 4.

The second reporting manner is described below with reference to specific examples.

### Example 10

In Example 10, the measurement instance is a trigger based measurement instance, and the sensing by proxy device reports one or more measurement results by using a TXOP of the measurement instance.

As shown in FIG. 21, the sensing by proxy requester is a STA1, and the sensing signal receivers include a STA2 to STA5. After a polling process and a measurement process, the sensing by proxy device may trigger, in batches, the sensing signal receivers to report measurement results.

In Example 10, the sensing by proxy device triggers, at one time, some sensing signal receivers to report measurement results. For example, OFDMA RUs for reporting measurement results are insufficient, or some sensing signal receivers require a relatively long processing time to generate the measurement results.

For example, as shown in FIG. 21, the sensing by proxy device first triggers the STA2, STA3 and STA4 to report measurement results, and after receiving a sensing report trigger frame of the sensing by proxy device, each of the STA2, STA3 and STA4 transmits a sensing report frame to the sensing by proxy device.

Specifically, the STA2 transmits a sensing report frame R1_2, the STA3 transmits a sensing report frame R1_3, and the STA4 transmits a sensing report frame R1_4. The sensing report frame R1_2, the sensing report frame R1_3, and the sensing report frame R1_4 respectively include measurement results of the STA2, STA3, and STA4 in the present measurement instance, or may also include measurement results in a previous measurement instance.

Further, the sensing by proxy device triggers the STA5 to report a measurement result. After receiving the sensing report trigger frame of the sensing by proxy device, the STA5 transmits a sensing report frame R1_5 to the sensing by proxy device, where the sensing report frame 1_5 includes the measurement result of the STA5 in the present measurement instance, or may also include a measurement result in the previous measurement instance.

After receiving the foregoing sensing report frames, the sensing by proxy device transmits a proxy report frame to the sensing by proxy device, and the proxy report frame includes measurement results included in the sensing report frame R1_2, the sensing report frame R1_3, the sensing report frame R1_4, and the sensing report frame R1_5.

It may be learned from the foregoing reporting process that, compared with Example 1, there is one less transmission of one or more sensing reports frame in Example 10.

### Example 11

In Example 11, the measurement instance is a trigger based measurement instance, and the sensing by proxy device reports one or more measurement results by using a TXOP obtained after the measurement instance.

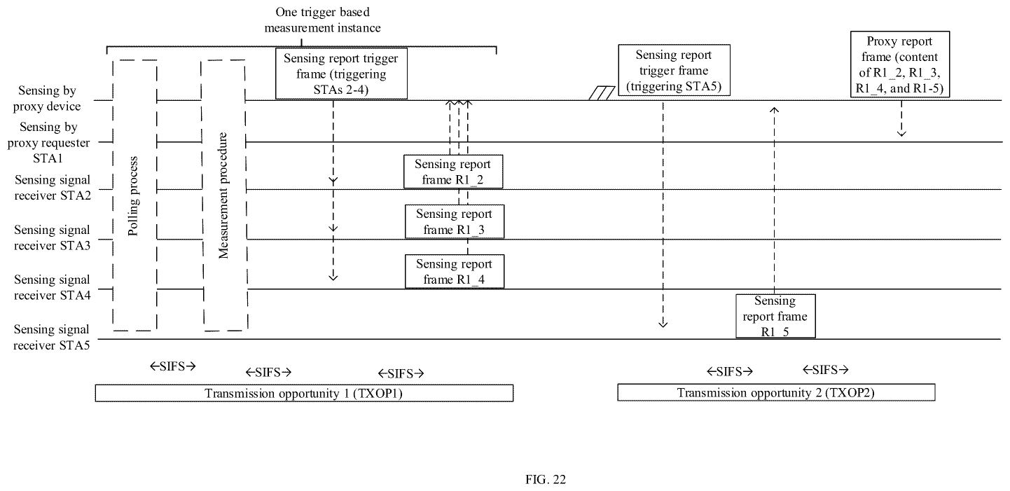

As shown in FIG. 22, the sensing by proxy requester is a STA1, and the sensing signal receivers include a STA2 to a STA5. After a polling process and a measurement process, the sensing by proxy device may trigger, in batches, the sensing signal receivers to report measurement results.

In Example 11, for a sensing signal receiver that does not support immediate report, after the measurement instance, the sensing by proxy device triggers the sensing signal receiver to perform measurement and reporting.

For example, as shown in FIG. 22, the sensing by proxy device first triggers the STA2, STA3 and STA4 to report measurement results, and after receiving a sensing report trigger frame of the sensing by proxy device, each of the STA2, STA3 and STA4 transmits a sensing report frame to the sensing by proxy device.

Specifically, the STA2 transmits a sensing report frame R1_2, the STA3 transmits a sensing report frame R1_3, and the STA4 transmits a sensing report frame R1_4. The sensing report frame R1_2, the sensing report frame R1_3, and the sensing report frame R1_4 respectively include measurement results of the STA2, STA3, and STA4 in the present measurement instance, or may also include measurement results in a previous measurement instance.

Further, after the measurement instance, the sensing by proxy device contends for a channel again to obtain a TXOP 2, and transmits, based on the TXOP 2, a sensing report trigger frame to trigger the STA5 to report a measurement result. After receiving the sensing report trigger frame of the sensing by proxy device, the STA5 transmits a sensing report frame R1_5 to the sensing by proxy device, where the sensing report frame 1_5 includes the measurement result of the STA5 in the present measurement instance.

After receiving the foregoing sensing report frames, the sensing by proxy device transmits a proxy report frame to the sensing by proxy device, and the proxy report frame includes measurement results included in the sensing report frame R1_2, the sensing report frame R1_3, the sensing report frame R1_4, and the sensing report frame R1_5.

It may be learned from the foregoing reporting process that, compared with Example 3, there is one less transmission of one or more sensing report frames in Example 11.

### Embodiment 3: The Third Reporting Manner (Reporting in a Unit of a Specific Quantity of Measurement Instances, Namely, Instance Specific Forwarding)

In some other embodiments of this application, the S210 includes:
transmitting, by the first device, the first report frame to the second device in a case of receiving all measurement results of each measurement instance in N measurement instances, where the first report frame includes all measurement results of each measurement instance in the N measurement instances, and N is a positive integer.

That is to say, the sensing by proxy device may report the measurement results in a unit of one or more measurement instances.

Specifically, in Embodiment 3, after receiving a measurement result of a sensing signal receiver, the sensing by proxy device may cache the measurement result. After all measurement results of N measurement instances are collected, the sensing by proxy device reports the measurement results. Since the measurement results are processed by the sensing by proxy requester in a unit of a measurement instance, adopting this reporting manner is helpful to reduce processing complexity of the sensing by proxy requester.

In some embodiments, the N may be one or more.

That is to say, the sensing by proxy device may report all measurement results of one measurement instance at one time, or may report all measurement results of a plurality of measurement instances at one time.

Optionally, when N is 1, the sensing by proxy device may report all measurement results of the present measurement instance, or may also report all measurement results of a previous measurement instance.

In some embodiments, the N is predefined or indicated by the second device.

For example, the N is indicated by the second device by using a first request frame, where the first request frame is used to request the first device working as a proxy to establish a measurement setup.

In some embodiments, the last measurement instance in the N measurement instances is a sixth measurement instance, a measurement result of the sixth measurement instance is received based on a third TXOP, the first report frame is reported based on the third TXOP or a fourth TXOP, and the fourth TXOP is a TXOP obtained after the third TXOP.

### Example 12

In Example 12, the measurement instance is a trigger based measurement instance, and N=1.

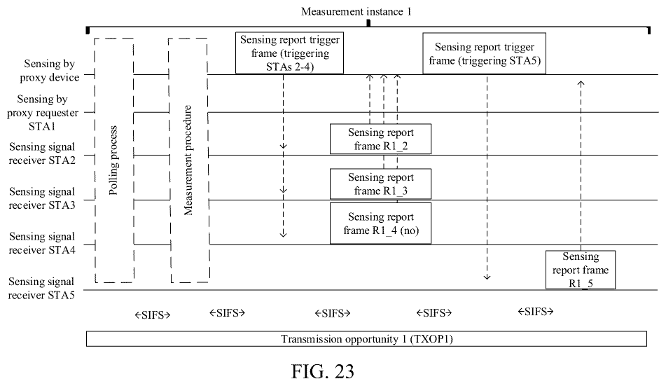

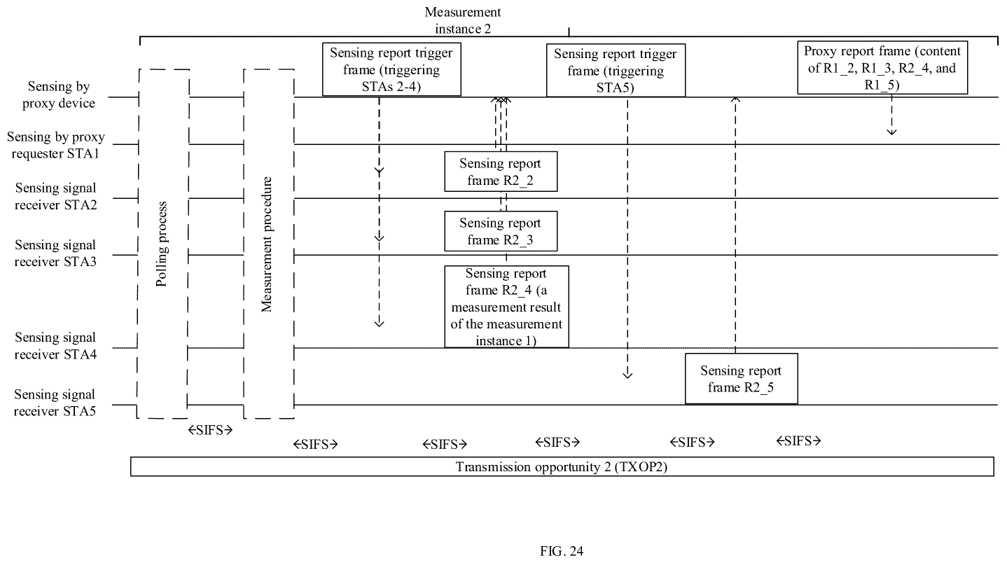

With reference to FIG. 23 and FIG. 24, two measurement instances, namely, a measurement instance 1 and a measurement instance 2, that are adjacent in a time sequence are used as an example to illustrate a specific reporting manner, where the measurement instance 1 is the first measurement instance.

As shown in FIG. 23 and FIG. 24, the sensing by proxy requester is a STA1, and the sensing signal receivers include a STA2 to a STA5. The STA4 does not support immediate report, and other STAs all support immediate report. After a polling process and a measurement process, the sensing by proxy device may trigger, in batches, the sensing signal receivers to report measurement results.

As shown in FIG. 23, in the measurement instance 1, the sensing by proxy device first triggers the STA2, STA3 and STA4 to report measurement results, and after receiving a sensing report trigger frame of the sensing by proxy device, each of the STA2, STA3 and STA4 transmits a sensing report frame to the sensing by proxy device.

Specifically, the STA2 transmits a sensing report frame R1_2, the STA3 transmits a sensing report frame R1_3, and the STA4 transmits a sensing report frame R1_4. The sensing report frame R1_2 and the sensing report frame R1_3 include measurement results of the measurement instance 1, and the sensing report frame R1_4 does not include a measurement result, or includes an invalid measurement result.

Then, the sensing by proxy device triggers the STA5 to report a measurement result, and the STA5 transmits, to the sensing by proxy device, a sensing report frame R1_5 that includes the measurement result of the measurement instance 1.

As shown in FIG. 24, in the measurement instance 2, the sensing by proxy device first triggers the STA2, STA3 and STA4 to report measurement results, and after receiving a sensing report trigger frame of the sensing by proxy device, each of the STA2, STA3 and STA4 transmits a sensing report frame to the sensing by proxy device.

Specifically, the STA2 transmits a sensing report frame R2_2, the STA3 transmits a sensing report frame R2_3, and the STA4 transmits a sensing report frame R2_4. The sensing report frame R2_2 and the sensing report frame R2_3 include measurement results of the measurement instance 2, and the sensing report frame R2_4 includes a measurement result of the measurement instance 1.

Then, the sensing by proxy device triggers the STA5 to report a measurement result, and the STA5 transmits, to the sensing by proxy device, a sensing report frame R2_5 that includes the measurement result of the measurement instance 2.

In this way, the sensing by proxy device obtains all measurement results of the measurement instance 1, and then may transmit a proxy report frame to the sensing by proxy requester. The proxy report frame includes measurement results included in the sensing report frame R1_2, the sensing report frame R1_3, the sensing report frame R2_4, and the sensing report frame R1_5, namely, all measurement results of the measurement instance 1.

In some embodiments of this application, the proxy report frame may further include second indication information, where the second indication information is used to indicate whether the proxy report frame is the last report frame of a measurement instance.

In some embodiments, for the first reporting manner and the second reporting manner, a measurement result of one measurement instance may be transmitted by using a plurality of proxy report frames. In this case, it needs to indicate whether the proxy report frame is the last proxy report frame of the measurement instance.

For example, there are four sensing signal receivers (STA2, STA3, STA4, and STA5) in a measurement instance A that is trigger based and corresponding to a measurement setup M1 established by a sensing by proxy device (for example, an AP) according to a request of a sensing by proxy requester (for example, a STA1). The first proxy report frame transmitted by the sensing by proxy device includes measurement results of the STA2, STA3, and STA4, that is, not all measurement results of the measurement instance A is included. In this case, the proxy report frame indicates that the proxy report frame is not the last proxy report frame of the measurement instance A. Further, the second proxy report frame transmitted by the sensing by proxy device includes a measurement result of the STA5. In this case, it may be indicated that the proxy report frame is the last proxy report frame of the measurement instance A.

For another example, a quantity of sensing signal receivers in a measurement instance changes. There are two sensing signal receivers (a STA2 and a STA3) in a measurement instance B that is trigger based and corresponding to a measurement setup M2 established by a sensing by proxy device (for example, an AP) according to a request of a sensing by proxy requester (for example, a STA1). The first proxy report frame transmitted by the sensing by proxy device includes measurement results of the STA2 and STA3. In this case, it may be indicated that the proxy device frame is the last proxy report frame of the measurement instance B. There are three sensing signal receivers (a STA3, a STA4 and a STA5) in a measurement instance C corresponding to the measurement setup M2. In this case, the first proxy report frame transmitted by the sensing by proxy device includes measurement results of the STA3 and STA4. In this case, it needs to indicate that the proxy report frame is not the last proxy report frame of the measurement instance C. Further, the second proxy report frame transmitted by the sensing by proxy device includes a measurement result of the STA5. In this case, it may be indicated that the proxy report frame is the last proxy report frame of the measurement instance C.

For another example, a quantity of sensing signal receivers actually participating in measurement is inconsistent with a quantity of sensing signal receivers required or recommended by the sensing by proxy requester. For example, a sensing by proxy requester (for example, a STA1) requires two sensing signal receivers. There are four sensing signal receivers (a STA2, a STA3, a STA4, and a STA5) in a measurement instance D that is trigger based and corresponding to a measurement setup M3 established by the sensing by proxy device (for example, an AP). The first proxy report frame transmitted by the sensing by proxy device includes measurement results of the STA2 and STA3. In this case, it is indicated that the proxy report frame is not the last proxy report frame of the measurement instance D. Further, the second proxy report frame transmitted by the sensing by proxy device includes measurement results of the STA4 and STA5. In this case, it may be indicated that the proxy report frame is the last proxy report frame of the measurement instance D.

Optionally, in some embodiments, for the first reporting manner or the second reporting manner, if the sensing by proxy requester learns a quantity of measurement results of each measurement instance and the quantity of measurement results of each measurement instance remains unchanged, the sensing by proxy device may not indicate in a proxy report frame whether the proxy report frame is the last proxy report frame of the measurement instance.

For example, there are always two sensing signal receivers (a STA2 and a STA3) in a measurement instance E that is trigger based and corresponding to a measurement setup M4 established by a sensing by proxy device (such as an AP) according to a request of a sensing by proxy requester (such as a STA1). After the sensing by proxy device reports measurement results of the measurement instance E of the STA2 and STA3 to the sensing by proxy requester, the sensing by proxy requester may determine all received measurement results of the measurement instance E.

For another example, there is only one sensing signal receiver (a STA2) in a measurement instance F that is non-trigger based and corresponding to a measurement setup M5 established by a sensing by proxy device (such as an AP) according to a request of a sensing by proxy requester (such as a STA1). After the sensing by proxy device reports a measurement result of the STA2, the sensing by proxy requester may determine all received measurement results of the measurement instance F.

In some embodiments of this application, the method 200 further includes:
if the second device is a sensing signal receiver of a first measurement setup, determining, by the first device depending on whether a first measurement instance is shared by another measurement setup that is different from the first measurement setup, whether to trigger the second device to report a measurement result.

For example, if the first measurement instance is not shared by the another measurement setup that is different from the first measurement setup, it is determined that the second device is not triggered to report the measurement result, that is, the measurement result of the first measurement instance does not need to be reported to another sensing by proxy requester, and therefore, the second device may not be triggered to report the measurement result.

For another example, if the first measurement instance is shared by the another measurement setup that is different from the first measurement setup, but the measurement result of the second device is only used by the second device, it is determined that the second device is not triggered to report the measurement result.

In other words, if a sensing by proxy requester, also as a sensing signal receiver, participates in one or more measurement setups established according to a sensing by proxy request transmitted by the sensing by proxy requester, and a measurement result of the sensing by proxy requester is not used by any measurement setup that is different from the one or more sensing measurement setups, then during or after a measurement reporting phase of the measurement instance of the one or more measurement setups, the sensing by proxy device does not request the sensing by proxy requester to report a measurement result of a corresponding measurement instance.

This is described with reference to a specific example shown in FIG. 25.

As shown in FIG. 25, a sensing by proxy requester (for example, a STA1) requests a sensing by proxy device (for example, an AP) to establish a measurement setup M6. A trigger based measurement instance G is separate, non-shared, and is only used by the measurement setup M6. In the measurement instance G, the STA1 also participates in downlink measurement as a sensing signal receiver. In this case, in the reporting phase, in order to reduce a network load, the sensing by proxy device may not request the STA1 to report a measurement result of the measurement instance G, for example, triggering of the STA1 is not indicated in a sensing report trigger frame.

For another example, a sensing initiator (for example, an AP) establishes a measurement setup M7, and a sensing by proxy requester (for example, a STA1) requests a sensing by proxy device (for example, an AP) to establish a measurement setup M8. For the measurement setup M7, a STA2 and a STA3 are required to report measurement results, and for the measurement setup M8, the STA1, the STA2, and the STA3 are required to report measurement results. A trigger based measurement instance H is shared and used by the measurement setup M7 and the measurement setup M8. In the measurement instance H, the STA1 also participates in downlink measurement as a sensing signal receiver. Because only the measurement setup M8 requires the measurement result of the STA1, in order to reduce a network load during the reporting phase, the sensing by proxy device may not request the STA1 to report a measurement result of the measurement instance H, for example, triggering of the STA1 is not indicated in a sensing reporting trigger frame.

A frame structure design of the first report frame is described below in combination with specific embodiments.

In some embodiments of this application, the first report frame may be an action frame or an action no acknowledgment frame (Action No Ack), that is, a function of reporting sensing by proxy report information (including the foregoing measurement result information) may be implemented by using the action frame.

In some embodiments, an existing action frame type (for example, a public action frame type) may be used to carry the sensing by proxy report information, or a new action frame type (for example, a protected sensing action frame type (Protected Sensing Action Frames)) may be added to carry the sensing by proxy report information. For example, a sensing action frame may be defined, and the sensing action frame is used to carry the sensing by proxy report information.

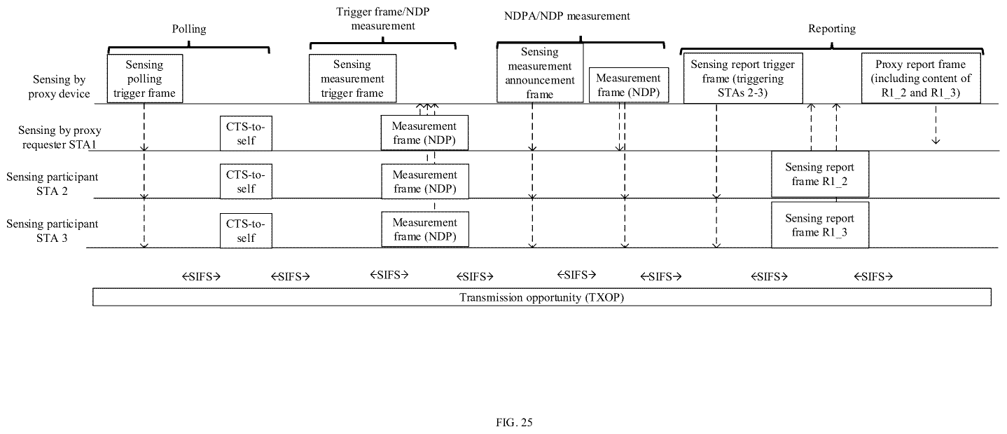

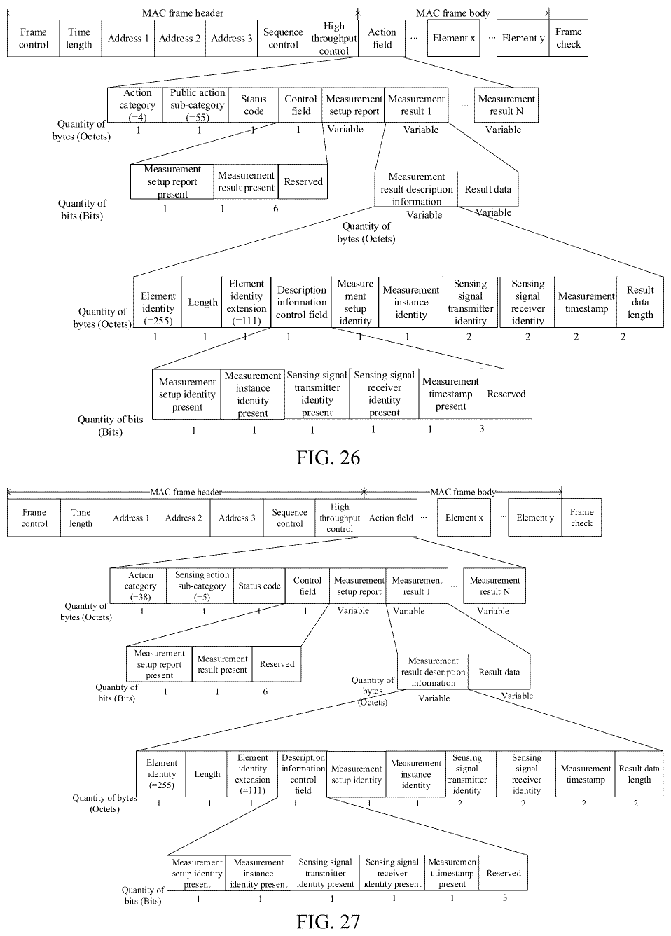

FIG. 26 is a schematic diagram of a format of a first report frame implemented by using a public action frame according to this application. It should be understood that a location and a size of each field in the frame format shown in FIG. 26 are merely examples, and may be flexibly adjusted according to actual needs or content that is carried, and this application is not limited thereto.

As shown in FIG. 26, an action field of the first report frame includes the following fields:
an action category field, for example, if a value is 4, it indicates that the action frame is a public action frame; and
a public action sub-category (Public Action Field) field, for example, if a value is a reserved value (any value from 46 to 255, with 55 being used as an example), it indicates that the public action frame is a sensing by proxy report frame (SBP Report frame).

In some embodiments, the first report frame includes at least one measurement result field, and each measurement result field is used to carry a measurement result of a sensing signal receiver.

By way of example rather than limitation, as shown in FIG. 26, the measurement result field includes at least one of the following fields:
a measurement setup identity field (Measurement Setup ID), used to indicate an identity of a measurement setup corresponding to the measurement result;
a measurement instance identity field (Measurement Instance ID), used to indicate an identity of a measurement instance corresponding to the measurement result;
a sensing signal transmitter identity field, used to indicate an identity of a sensing signal transmitter corresponding to the measurement result;
a sensing signal receiver identity field, used to indicate an identity of a sensing signal receiver corresponding to the measurement result;
a measurement timestamp field, used to indicate information about measurement time corresponding to the measurement result;
a result data length field, used to indicate a length of data of the measurement result, for example, the unit is byte; and
a result data field, used to indicate data of the measurement result of the sensing signal receiver in one measurement instance.

In some embodiments, a measurement setup identity indicated in the measurement setup identity field belongs to a first measurement setup identity space.

In some embodiments, the data of the measurement result may include, for example, at least one of the following:
CSI data, generally refers to a channel frequency response (CFR);
beam signal-to-noise ratio data (Beam SNR);
truncated channel impulse response (TCIR) data;
channel state information amplitude only information (CSI Amplitude only);
channel state information phase only information (CSI Phase only);
signal angle of arrival information (Angle of Arrival, AoA); and
signal angle of departure information (Angle of Departure, AoD).

In some embodiments, the measurement result field may include a measurement result description information field and the result data field. The measurement result description information field may include the foregoing fields. Optionally, the measurement result description information field may be an element field, for example, a reserved value (for example, any value from 111 to 255, with 111 being used as an example) of an element identity extension field may be used to indicate that the element is a new extension element for indicating description information of the measurement result; or may be a non-element field, which is not limited in this application.

In some embodiments, the measurement result field further includes a control field, and the control field includes at least one of the following fields:
a measurement instance identity present field, used to indicate whether the measurement instance identity field presents in the measurement result field;
a measurement setup identity present field, used to indicate whether the measurement setup identity field presents in the measurement result field;
a sensing signal transmitter identity present field, used to indicate whether the sensing signal transmitter identity presents in the measurement result field;
a sensing signal receiver identity present field, used to indicate whether the sensing signal receiver identity presents in the measurement result field; and
a measurement timestamp present field, used to indicate whether the measurement timestamp field presents in the measurement result field.

Optionally, the control field is also referred to as a description information control field.

In some embodiments, the first report frame may also be used to report an establishment result in a measurement setup phase. Therefore, the first report frame may further include measurement setup report information, for example, whether a measurement setup is established successfully, or a cause of an establishment failure.

In some embodiments, as shown in FIG. 26, the first report frame further includes a measurement setup report field for carrying measurement setup report information. For example, part or all information about a measurement setup established by a proxy is used to assist a sensing by proxy requester in processing measurement result data.

In some embodiments, as shown in FIG. 26, the action field of the first report frame may further include a control field, which is used to indicate whether one or more subsequent fields present, such as whether a measurement setup report field presents and/or a measurement result field presents. For example, the control field may include:
a measurement setup report present field, used to indicate whether the first report frame includes the measurement setup report field; and
a measurement result present field, used to indicate whether the first report frame includes the measurement result field.

In an embodiment, if the measurement setup report present field is set to 1, it indicates yes; otherwise, the measurement setup report present field is set to 0.

In another embodiment, if the measurement setup report present field is set to 0, it indicates yes; otherwise, the measurement setup report present field is set to 1.

In an embodiment, if the measurement result present field is set to 1, it indicates yes; otherwise, the measurement result present field is set to 0.

In another embodiment, if the measurement result present field is set to 0, it indicates yes; otherwise, the measurement result present field is set to 1.

In some embodiments, the first report frame further includes: a status code field, which is used to indicate an establishment result of a measurement setup established by a proxy and/or a cause for failing to establish a measurement setup.

By way of example rather than limitation, if the status code field is set to 0, it indicates success (or that no error occurs); if the status code field is set to 131, it indicates that a measurement setup fails to be established due to insufficient quantity of sensing participants; if the status code field is set to 132, it indicates that a measurement setup fails to be established because a sensing result cannot be reported immediately; if the status code field is set to 133, it indicates that a requirement of a minimum quantity of sensing responders cannot be met due to a decrease in a total quantity of stations participating in measurement in a measurement process; if the status code field is set to 134, it indicates that an established measurement setup cannot be maintained due to a change in an operating mode (OM) of a sensing responder in a measurement process; if the status code field is set to 135, it indicates that a load of a basic service set (BSS) is high and a sensing measurement needs to be stopped.

In some scenarios, when a STA has insufficient power but wants to extend operation, the operating mode is changed (reducing a bandwidth and/or reducing a quantity of transmit spatial flows that can be supported and/or reducing a quantity of receive spatial flows that can be supported) to achieve an effect of extending operation duration. After the operating mode changes, the sensing process may be affected. For example, the less the bandwidth, the larger a quantization error of a measurement result, and the less a quantity of spatial flows, a lower CSI matrix dimension of the measurement result, thereby reducing sensing accuracy. When an operating mode of a sensing responder (for example, a non-AP STA) changes, the sensing by proxy responder transmits, to a sensing initiator (for example, an AP), an operating mode notification (OMN) (which may be an OMN frame, or may be another frame carrying an OMN element) or an operating mode indication (OMI) (which may be an operating mode control subfield (OM Control subfield) and/or an EHT operating mode control subfield (EHT OM Control subfield)).

It should be understood that the correspondence between a value and meaning of a status code field is only an example, as long as each meaning corresponds to a unique status code.

FIG. 27 is a schematic diagram of a format of a first report frame implemented by using a newly defined sensing action frame according to an embodiment of this application. It should be understood that a location and a size of each field in the frame format shown in FIG. 27 are merely examples, and may be flexibly adjusted according to actual needs or content that is carried, and this application is not limited thereto.

As shown in FIG. 27, an action field of the first report frame includes the following fields:
an action category field, for example, if a value is a third value, it indicates that the action frame is a newly defined protected sensing action frame, where the third value is a reserved value, for example, 38; and
a sensing action sub-category (Sensing Action Field) field, for example, if a value is a fourth value (any value from 0 to 255, with 5 being used as an example), it indicates that the sensing action frame is a sensing by proxy report frame (SBP Report frame).

It should be understood that the meaning of each field in the frame format shown in FIG. 27 is the same as the meaning of a corresponding field in the frame format shown in FIG. 26. For detailed description, refer to the relevant description of FIG. 26, which will not be repeated herein.

In some embodiments, each measurement result description information field includes the foregoing description information fields, that is, corresponding bits in the description information control field all indicate present. In this case, description information of a measurement result may be determined based on description information indicated in the measurement result description information field.

In another embodiment, the description information of the measurement result may be determined by using an element inheritance method. For example, if all description information fields in the first measurement result description information element are present, in a subsequent measurement result description information element, if a description field is not present, a value of the description information field may use a value of a corresponding field of a previous element; if the description information field is present, a value of the description information field in a current measurement result description information element is used.

For example, in a measurement result description information element in the first measurement result field, a measurement setup identity is 1, a measurement instance identifier is 5, a sensing signal transmitter identity is 3, a sensing signal receiver identity is 9, and a measurement timestamp is 3000. If a measurement result description information element in the second measurement result field does not include a measurement setup identity field, the measurement setup identity is also 1. If a measurement result description information element in the third measurement result field includes a measurement setup identity 4, the measurement setup identity is 4. If a measurement result description information element in the fourth measurement result field does not include a measurement setup identity, the measurement setup identity is also 4.

In embodiments of this application, the first report frame may further indicate whether the first report frame is the last proxy report frame of a measurement instance, that is, the first report frame may include the second indication information. In some embodiments, the first report frame carrying the second indication information may be implemented by using an existing action frame type (for example, a public action frame type), or may be implemented by using a newly added action frame type (for example, a protected sensing action frame type (Protected Sensing Action Frames)).

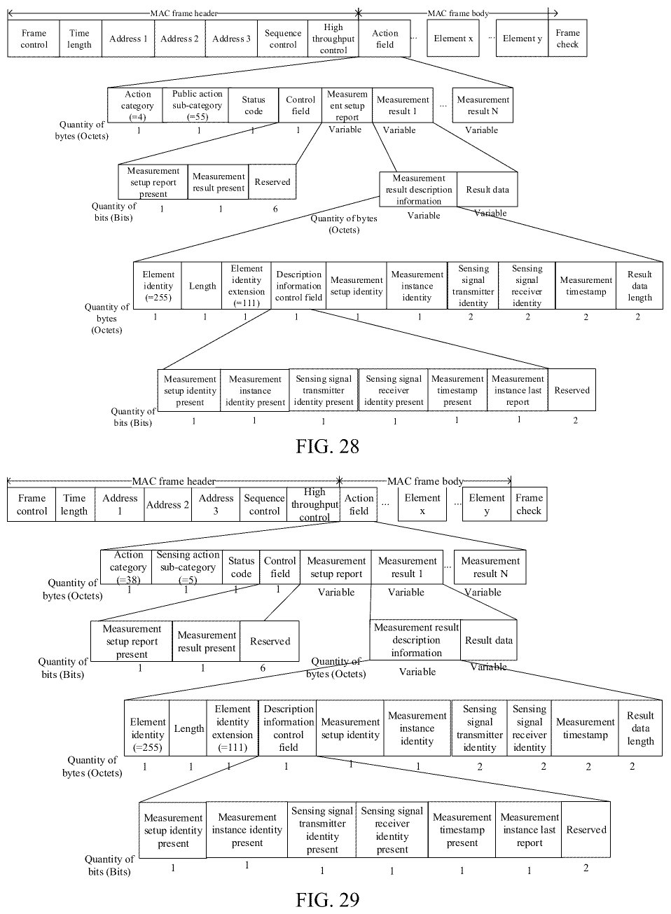

FIG. 28 and FIG. 29 are schematic format diagrams of first report frames that carry the second indication information and are implemented by using a public action frame and a newly defined sensing action frame, respectively. It should be understood that a location and a size of each field in frame formats shown in FIG. 28 and FIG. 29 are merely examples, and may be flexibly adjusted according to actual needs or content that is carried, and this application is not limited thereto.

For example, as shown in FIG. 28 and FIG. 29, a measurement result field further includes a measurement instance last report field, which is used to indicate whether the measurement result is the last measurement result of a corresponding measurement instance, that is, whether the frame is the last proxy report frame of the measurement instance. In an embodiment, if this field is set to 1, it indicates yes; otherwise, this field is set to 0. In another embodiment, if this field is set to 0, it indicates yes; otherwise, this field is set to 1. It should be understood that meaning of other fields in the frame formats shown in FIG. 28 and FIG. 29 corresponds to relevant description of corresponding fields in the frame formats shown in FIG. 26 and FIG. 27, and details are not described herein again.

In some embodiments, a transmitter of a sensing measurement result may be a sensing signal receiver, and a receiver of the sensing measurement result may be a sensing by proxy device or a sensing initiator.

For example, the sensing signal receiver may transmit, to the sensing by proxy device or the sensing initiator, a sensing measurement report frame (or referred to as a sensing report frame) carrying the sensing measurement result.

In some embodiments, the transmitter of the sensing measurement result may be a sensing by proxy device, and the receiver of the sensing measurement result may be a sensing by proxy requester.

For example, the sensing by proxy device may transmit, to the sensing by proxy requester, a sensing by proxy report frame (or referred to as a proxy report frame) carrying the sensing measurement result.

For the convenience of distinction and description, in following embodiments, a frame used to transmit a sensing measurement result is referred to as a report frame, that is, the report frame may include a sensing measurement report frame and/or a sensing by proxy report frame.

In some embodiments, a sensing measurement result may only be transmitted in a specific time period. In other words, there is a requirement for a transmission period (or transmission timing) for the sensing measurement result.

For example, in a trigger based measurement instance, when receiving a sensing report trigger frame transmitted by the sensing initiator, the sensing signal receiver needs to transmit a protected sensing measurement report frame after a SIFS regardless of whether currently there is another protected management frame that is cached to be transmitted.

For another example, in a trigger based measurement instance, after the sensing by proxy device receives a sensing measurement report frame transmitted by the sensing signal receiver, the sensing by proxy device needs to transmit a protected sensing by proxy report frame after a SIFS, regardless of whether currently there is another protected management frame that is cached to be transmitted.

Generally, to prevent a replay attack, a transmitter sets a self-incrementing packet number (PN) in the protected management frame. The packet number is not repeated for each MAC protocol data unit (MPDU) encrypted by using a same temporary key, and an initial value is 0. A receiver correspondingly maintains one or more replay counters, and an initial value of the replay counter is 0. After successfully receiving a frame (including successfully decrypted), the receiver updates a corresponding value of the replay counter to a PN value in the successfully received frame. If the receiver performs replay detection before decrypting a frame body, the value of the replay counter is updated to the PN value in the frame only when decryption succeeds and the frame is accepted. The receiver may use a packet number of a currently received frame to detect whether the frame is a replayed frame. If the packet number of the currently received frame is less than or equal to a current value of the replay counter, it is determined that the frame is a replayed frame, and thus the frame is discarded. For example, if the receiver successfully receives a frame with the PN being 5, the value of the replay counter is updated to 5. If a frame with the PN being 5 or less is received later, the frame will be discarded and the receiver will not update the replay counter again.

Based on the foregoing mechanism, there may be some problems. Examples are provided as follows.
1. If a protected sensing measurement report frame shares a replay counter with another protected management frame, when the sensing signal receiver receives a sensing report trigger frame, there is also another protected management frame that is cached in its cache queue to be transmitted. If the receiver transmits the protected sensing measurement report frame before the another protected management frame that is cached, since a PN of the another protected management frame that is cached is less than a PN of the protected sensing measurement report frame, the receiver will update a value of the replay counter to the PN of the protected sensing measurement report frame after successfully receiving the protected sensing measurement report frame. Thereafter, when the receiver receives another protected management frame, the receiver will compare a PN of the another protected management frame with the value of the replay counter, and then determine that the another protected management frame is a replayed frame and then discard the another protected management frame. For example, if a sensing measurement report frame with the PN being 7 is transmitted before another protected management frame with the PN being 6, the another protected management frame with the PN being 6 will be discarded.
2. If a protected sensing measurement report frame shares a replay counter with another protected management frame, if the sensing signal receiver prepares and caches the protected sensing measurement report frame, but needs to wait for a specific time (for example, after a sensing report trigger frame is received) to report, cache queue blocking (Head of Line Blocking, HOL Blocking) occurs, resulting in the another protected management frame cached following the protected sensing measurement report frame cannot be transmitted in time. For example, another protected management frame with the PN being 8 needs to wait and cannot be transmitted until a sensing measurement report frame with the PN being 7 is transmitted, even if a current channel is idle.

To solve the foregoing problems, in some embodiments of this application, the receiver of the sensing measurement result may maintain a separate replay counter (noted as a first replay counter) for a protected report frame to be received, and check, based on a PN in a protected report frame that is received, whether the protected report frame is a replayed frame. For example, if a PN in a protected report frame that is currently received is less than or equal to a current value of the first replay counter, it is determined that the protected report frame is a replayed frame and discarding is further performed; if a PN in a protected report frame that is currently received is greater than the current value of the first replay counter, the value of the first replay counter is updated to a value of the PN in the protected report frame.

In some embodiments, the first replay counter and a second replay counter count separately, where the second replay counter is an existing replay counter and the first replay counter is a newly added replay counter.

In some embodiments, the second replay counter includes but is not limited to at least one of the following:
a replay counter used for another quality-of-service management frame (QMF); and
a replay counter used for fine timing measurement (FTM) for ranging and location measurement report (LMR).

For example, a transmitter sequentially transmits a protected sensing measurement report frame with the PN being 22, another QMF with the PN being 20, another QMF with the PN being 21, another QMF with the PN being 23, and a protected sensing measurement report frame with the PN being 24, and a receiver uses the first replay counter to perform replay detection when receiving the frame with the PN being 22. In this case, an initial value of the first replay count is 0, and 22 is greater than 0, so that the receiver determines that the frame with the PN being 22 is not a replayed frame. If the frame with the PN being 22 is successfully decrypted and received, the value of the first replay count is updated to 22. The receiver uses the second replay counter to perform replay detection when receiving the frame with the PN being 20. In this case, a value of the second replay counter is 19, and 20 is greater than 19, so that the receiver determines that the frame with the PN being 20 is not a replayed frame. If the frame with the PN being 20 is successfully decrypted and received, the value of the second replay counter is updated to 20. The receiver processes the frames with the PN being 21 and the PN being 23 in a similar manner. The receiver uses the first replay counter to perform replay detection when receiving the frame with the PN being 24. In this case, a value of the first replay counter is 22, and 24 is greater than 22, so that the receiver determines that the frame with the PN being 24 is not a replayed frame. If the frame with the PN being 24 is successfully decrypted and received, a value of a replay counter A is updated to 24.

Therefore, in embodiments of this application, a separate replay counter is used to count the PN of a protected report frame. Thus, even if the protected report frame is transmitted before another protected management frame, since the receiver checks the PN in frames based on different values of replay counters, a problem that a PN of the another protected management frame is discarded by the receiver due to the PN being less than or equal to a current value of a replay counter because the protected report frame is transmitted in advance will not occur.

In addition, a separate replay counter is used to count the PN of the protected report frame. In this way, when the protected report frame does not reach transmission timing, the transmitter may first transmit another protected management frame following the protected report frame in a cache queue, which is conductive to solve the problem that the another protected management frame cannot be able to be transmitted in time due to blocking of a cache queue caused when the protected report frame does not reach transmission timing. Moreover, since the receiver performs replay detection on the foregoing two frames based on different values of replay counters, the problem that a PN of the protected report frame that is delayed transmitted is discarded by the receive due to the PN being less than or equal to a current value of a corresponding replay counter will not occur.

In some embodiments, in a case in which a management frame protection function is activated (for example, a value of dot11RSNAProtectedManagementFramesActivated is true) after a robust security network association (RNSA) is established, the receiver of the protected report frame maintains a separate replay counter for receiving a unicast protected report frame for receiving unicast.

In some embodiments, the protected report frame that uses a separate replay counter and another protected sensing-related management frame may be set to correspond to different action frame types. In this way, the receiver for a frame may count corresponding replay counters based on an action frame type of the received frame.

For example, the protected report frame (including the protected sensing measurement report frame and/or the protected sensing by proxy report frame) correspond to a newly added sensing action frame type, such as a protected sensing action frame type (Protected Sensing Action Frames), and the another protected sensing-related management frame may use an existing protected action frame type, such as a protected dual public action frame type (Protected Dual of Public Action).

For another example, the protected report frame and the another protected sensing-related management frame both correspond to a newly added sensing action frame type, but correspond to different sensing action frame types.

In some embodiments, since the another protected sensing-related management frame does not have a requirement for a specific transmission period, an existing replay counter, such as the second replay counter, may be used, and specifically, for example, a same replay counter as another QMF is used.

In some embodiments, the another sensing-related management frame may include but is not limited to at least one of the following frames:
a sensing session establishment request frame, used to request establishment of a sensing session;
a sensing session establishment response frame, which is a response frame to the sensing session request frame;
a sensing session termination frame, used to terminate an established sensing session;
a sensing measurement establishment request frame, used to request establishment of sensing measurement;
a sensing measurement establishment response frame, which is a response frame to the sensing measurement establishment request frame;
a sensing measurement setup termination frame, used to terminate an established sensing measurement setup;
a sensing by proxy request frame, used to request a proxy to establish a sensing process;
a sensing by proxy response frame, which is a response frame to the sensing by proxy request frame; and
a sensing by proxy termination frame, used to terminate a sensing process established by a proxy.

In some embodiments, if the receiver performs replay detection before decrypting a protected frame, the receiver needs to detect whether a value of a corresponding replay counter is correct (that is, less than a value of a PN of a currently received frame). If the value of the corresponding replay counter is incorrect (for example, greater than or equal to the value of the PN of the currently received frame), the receiver needs to discard a current frame.

In some embodiments, if the receiver needs to use a separate replay counter to count the protected report frame, the transmitter needs to indicate, in a sensing field of the counter mode with cipher-block chaining message authentication code protocol (CCMP) or Galois/counter mode protocol (GCMP) header of the protected report frame, that the frame belongs to a protected report frame.

In some embodiments, the receiver updates a value of the first replay counter to a PN value in the protected report frame only when the protected report frame is successfully decrypted and accepted.

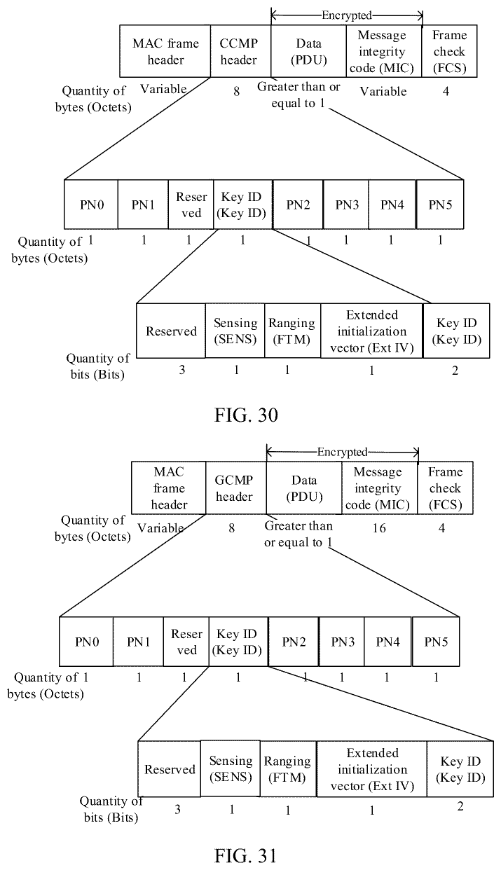

FIG. 30 is a schematic diagram of a format of a protected report frame indicated by using a CCMP header according to an embodiment of this application. As shown in FIG. 30, the frame includes a CCMP header, which may occupy, for example, 8 bytes.

In some embodiments, the CCMP header includes the following fields:
PN0, PN1, Key ID, PN2, PN3, PN4, and PN5, where each field occupies one byte.

In some embodiments, a reserved bit in the field key ID may be used as a sensing field to indicate a sensing action frame type of the frame, for example, the frame is a type of a protected sensing action frame.

In some embodiments, a PN in the frame may be a value of 48 bits, where the 48 bits are formed by 6 bytes of the field PN0, the field PN1, the field PN2, the field PN3, the field PN4, and the field PN5 in FIG. 30, where the PN5 is the most significant byte and the PN0 is the least significant byte.

In some embodiments, a bit value of an extended initialization vector (Ext IV) in the CCMP header is always set to 1.

FIG. 31 is a schematic diagram of a format of a protected report frame indicated by using a GCMP header according to an embodiment of this application. As shown in FIG. 31, the frame includes a GCMP header, which may occupy, for example, 8 bytes.

In some embodiments, the GCMP header includes the following fields:
PN0, PN1, Key ID, PN2, PN3, PN4, and PN5, where each field occupies one byte.

In some embodiments, a reserved bit in the field key ID may be used as a sensing field to indicate a sensing action frame type of the frame, for example, the frame is a type of a protected sensing action frame.

In some embodiments, a PN in the frame may be a value of 48 bits, where the 48 bits are formed by 6 bytes of the field PN0, the field PN1, the field PN2, the field PN3, the field PN4, and the field PN5 in FIG. 30, where the PN5 is the most significant byte and the PN0 is the least significant byte.

In some embodiments, a bit value of an extended initialization vector (Ext IV) in the GCMP header is always set to 1.

In some embodiments, a MAC frame header of secure and non-secure frames includes a sequence control field, where the sequence control field includes two subfields: a sequence number field and a fragment number field. The sequence control field is used for detection of retransmission of the secure and non-secure frames.

Since a sensing measurement result can only be transmitted in a specific time period, in order to better process retransmission of the secure and non-secure frames in a case of loss, in some embodiments of this application, sequence number space identities used by the sequence number subfield of a protected report frame (including a protected sensing measurement report frame and/or a protected sensing by proxy report frame) and a protected public action category report frame (including a public action category sensing measurement report frame and/or a public action category sensing by proxy report frame) belong to a first sequence number space.

In some embodiments, the first sequence number space and the second sequence number space are different from each other, the first sequence number space is a newly added independent sequence number space, and the second sequence number space is an existing sequence number space.

In some embodiments, the second sequence number space includes a sequence number space used for another QMF (for example, a sequence number space identified by an identifier SNS4).

In some embodiments, the first sequence number space includes a sequence number space identified by an identifier SNS9, and the second sequence number space may include sequence number spaces identified by identifiers SNS4 and SNS8.

In some embodiments, since another sensing-related management frame has no requirements for a transmission period, the another sensing-related management frame may use the second sequence number space, for example, use a same sequence number space as the another QMF (for example, the sequence number space identified by the identifier SNS4). That is, the protected report frame and the protected public action category report frame may use different sequence number spaces with another protected sensing-related management frame.

In some embodiments, receivers of the protected report frame (including the protected sensing measurement report frame and/or the protected sensing by proxy report frame) and the protected public action category report frame (including the public action category sensing measurement report frame and/or the public action category sensing by proxy report frame) may respectively cache the protected report frame and the protected public action category report frame that are received by using a first receiving cache.

In some embodiments, the first receiving cache and a second receiving cache are different from each other, the first receiving cache is a newly added separate receiving cache, and the second receiving cache is an existing receiving cache.

In some embodiments, the second receiving cache includes a receiving cache used for another QMF, such as receiving caches identified by identifiers RC6 and RC13.

In some embodiments, the first receiving cache includes a receiving cache identified by an identifier RC14, and the second receiving cache may include the receiving caches identified by the identifiers RC6 and RC13.

In some embodiments, since another protected sensing-related management frame has no requirements on a transmission period, the another protected sensing-related management frame may use a same receiving cache as the another QMF, such as the receiving cache identified by the identifier RC6.

That is, the protected report frame and the protected public action category report frame may use different receiving caches from the another protected sensing-related management frame.

By way of example rather than limitation, transmitter sequence number spaces may be shown in Table 3:

TABLE 3
Transmitter sequence number spaces

| Sequence | | | | | |
|---|---|---|---|---|---|
| number | | | | | Necessary |
| space | Sequence | | | | conditions for |
| identifier | number space | Applied to | Status | Multiplicity | transmitter |
| . . . | | | | | |
| SNS4 | QMF | A QMF station | Must be | a plurality | TR2 |
| | | for transmitting | implemented | of instances | |
| | | a QMF frame | | with an | |
| | | other than | | index of a | |
| | | protected FTM, | | tuple | |
| | | public action | | <address 1, | |
| | | category LMR, | | access | |
| | | protected | | category | |
| | | sensing report | | AC> | |
| | | and public | | | |
| | | action category | | | |
| | | sensing report | | | |
| . . . | | | | | |
| SNS8 | Protected fine | A station for | Must be | Single | |
| | timing | transmitting the | implemented | Instance | |
| | measurement | protected FTM | | | |
| | (FTM) and | or the public | | | |
| | public action | action category | | | |
| | category | LMR | | | |
| | location | | | | |
| | measurement | | | | |
| | report (LMR) | | | | |
| SNS9 | Protected | A station for | Must be | Single | |
| | sensing report | transmitting the | implemented | Instance | |
| | and public | protected | | | |
| | action category | sensing report | | | |
| | sensing report | or the public | | | |
| | | action category | | | |
| | | sensing report | | | |

By way of example rather than limitation, caches capable of being used by a receiver (Receiver caches) may be as shown in Table 4.

TABLE 4
Caches capable of being used by a receiver (Receiver caches)

| Receiver | | | | | Necessary |
|---|---|---|---|---|---|
| cache | | | | Multiplicity/Cache | conditions |
| identifier | Cache name | Applied to | Status | size | for receiver |
| . . . | | | | | |
| RC6 | QMF | A QMF | Must be | a plurality of | RR2 |
| | | station for | implemented | instances with an | RR3 |
| | | receiving a | | index of a tuple | RR5 |
| | | QMF frame | | <address 2, access | |
| | | other than | | category AC, | |
| | | protected | | sequence, | |
| | | FTM, public | | sequence | |
| | | action | | number>, | |
| | | category | | where at least one | |
| | | LMR, | | latest entry is | |
| | | protected | | cached in each | |
| | | sensing | | cache | |
| | | report and | | corresponding to | |
| | | public | | the index of the | |
| | | action | | tuple | |
| | | category | | | |
| | | sensing | | | |
| | | report | | | |
| . . . | | | | | |
| RC13 | Protected | A station for | Must be | a plurality of | RR1 |
| | fine timing | receiving | implemented | instances with an | RR2 |
| | measurement | the | | index of a tuple | RR5 |
| | (FTM) and | protected | | <address 2, access | |
| | public action | FTM or the | | category AC, | |
| | category | public | | sequence, | |
| | location | action | | sequence | |
| | measurement | category | | number>, | |
| | report | LMR | | where at least one | |
| | (LMR) | | | latest entry is | |
| | | | | cached in each | |
| | | | | cache | |
| | | | | corresponding to | |
| | | | | the address 2 | |
| RC14 | Protected | A station for | Must be | a plurality of | RR1 |
| | sensing | receiving | implemented | instances with an | RR2 |
| | report and | the | | index of a tuple | RR5 |
| | public action | protected | | <address 2, access | |
| | category | sensing | | category AC, | |
| | sensing | report or the | | sequence, | |
| | report | public | | sequence | |
| | | action | | number>, | |
| | | category | | where at least one | |
| | | sensing | | latest entry is | |
| | | report | | cached in each | |
| | | | | cache | |
| | | | | corresponding to | |
| | | | | the address 2 | |

It should be understood that, a specific implementation of the receiver of sensing measurement results performing, by using a separate replay counter, replay detection on a received report frame that carries the sensing measurement results may be applicable to a sensing process established by a proxy, or may be applicable to a sensing process that is not established by a proxy, for example, a sensing process autonomously established by the sensing initiator, which is not limited in this application.

Similarly, a specific implementation of a receiver of sensing measurement results receiving, by using a separate receiving cache, a report frame that carries the sensing measurement results may be applicable to a sensing process established by a proxy, or may be applicable to a sensing process that is not established by a proxy, for example, a sensing process autonomously established by the sensing initiator, which is not limited in this application.

Similarly, a specific implementation of a transmitter of the sensing measurement results transmitting, by using a separate sequence number space, a report frame that carries the sensing measurement results may be applicable to a sensing process established by a proxy, or may be applicable to a sensing process that is not established by a proxy, for example, a sensing process autonomously established by the sensing initiator, which is not limited in this application.

It should be noted that in another sensing scenario, similar designs may also be applied to reception or transmission of another frame that has a requirement on transmission timing, and this application is not limited to this.

In conclusion, embodiments of this application provide a variety of reporting manners of one or more measurement results, for example, reporting the one or more measurement results immediately upon receiving the one or more measurement results, or reporting the one or more measurement results after a measurement instance, or reporting the one or more measurement results in a unit of a specific quantity of measurement instances, or the like. This improves and optimizes a process in which a proxy reports one or more measurement results, and reporting one or more measurement results based on a reporting manner of embodiments of this application is conducive to reducing network load, and reducing processing complexity and energy consumption. In addition, the receiver of the sensing measurement result may perform, by using a separate replay counter, replay detection on a received protected report frame, which is helpful to avoid a case that another protected management frame is discarded because a protected report frame is transmitted in advance, and also avoid a case that the another protected management frame cannot be able to be transmitted in time due to blocking of a cache queue caused when the protected report frame does not reach transmission timing. Further, the protected report frame that uses a separate replay counter and another protected sensing-related management frame are set to correspond to different sensing action frame types, which is conductive to reducing complexity of using the separate replay counter by the receiver. For example, a sensing action frame type of a frame may be indicated by using a sensing field in a CCMP header or a GCMP header in the frame, so that replay detection may be performed before a frame body is decrypted.

Moreover, a transmitter of a protected report frame and a protected public action category report frame may transmit the protected report frame and the protected public action category report frame by using a separate sequence number space. Correspondingly, a receiver of the protected report frame and the protected public action category report frame may receive the protected report frame and the protected public action category report frame by using a separate receiving cache, which is beneficial to reduce implementation complexity of a frame retransmission function.

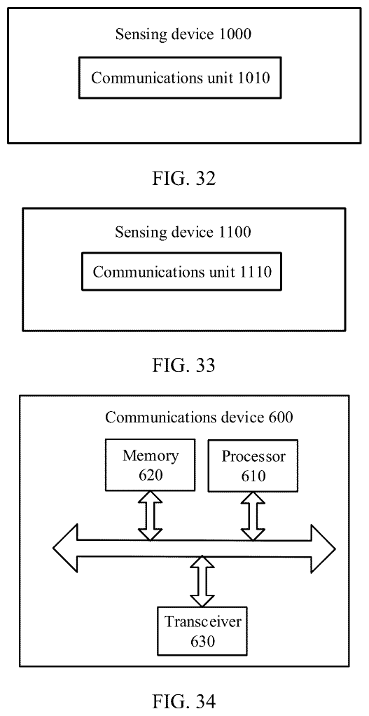

The foregoing describes method embodiments of this application in detail with reference to FIG. 8 to FIG. 31. The following describes apparatus embodiments of this application in detail with reference to FIG. 32 to FIG. 36. It should be understood that the apparatus embodiments are corresponding to the method embodiments. For similar descriptions, refer to the method embodiments.

FIG. 32 is a schematic block diagram of a sensing device according to an embodiment of this application. A sensing device 1000 in FIG. 32 includes:
a communications unit 1010, configured to transmit a first report frame to a second device, where the first report frame includes one or more measurement results of at least one measurement instance, one or more measurement results of each measurement instance includes a measurement result of at least one sensing signal receiver, the at least one measurement instance corresponds to at least one measurement setup, and the at least one measurement setup is established by the sensing device working as a proxy of the second device.

In some embodiments, the communications unit 1010 is further configured to:
transmit the first report frame to the second device in a case of receiving the measurement result of the at least one sensing signal receiver, where the first report frame includes the measurement result of the at least one sensing signal receiver.

In some embodiments, the communications unit 1010 is further configured to:
transmit the first report frame based on a first transmission opportunity TXOP or a second TXOP, where the measurement result of the at least one sensing signal receiver is received based on the first TXOP, and the second TXOP is a TXOP obtained after the first TXOP.

In some embodiments, the first TXOP is used for measurement of a second measurement instance, the measurement result of the at least one sensing signal receiver includes a measurement result of the second measurement instance and/or a measurement result of a first measurement instance, and the first measurement instance is a previous measurement instance of the second measurement instance.

In some embodiments, the communications unit 1010 is further configured to:
transmit a first report frame to the second device after each measurement instance, where the first report frame includes one or more measurement results received in the measurement instance or before a succeeding measurement instance.

In some embodiments, the communications unit 1010 is further configured to:
transmitting the first report frame to the second device based on a TXOP corresponding to the measurement instance; or
transmitting the first report frame to the second device based on a TXOP obtained after the measurement instance.

In some embodiments, the at least one measurement instance includes a fourth measurement instance, and a succeeding measurement instance of the fourth measurement instance is a fifth measurement instance. One or more measurement results received in the fourth measurement instance or one or more measurement results received before the fifth measurement instance includes one or more measurement results of the fourth measurement instance and/or one or more measurement results of a third measurement instance, and the third measurement instance is a previous measurement instance of the fourth measurement instance.

In some embodiments, the communications unit 1010 is further configured to:
transmit the first report frame to the second device in a case of receiving all measurement results of each measurement instance in N measurement instances, where the first report frame includes all measurement results of each measurement instance in the N measurement instances, and N is a positive integer.

In some embodiments, the N is predefined or indicated by the second device.

In some embodiments, the N is indicated by the second device by using a first request frame, and the first request frame is used to request the sensing device working as a proxy to establish the at least one measurement setup.

In some embodiments, the last measurement instance in the N measurement instances is a sixth measurement instance, a measurement result of the sixth measurement instance is received based on a third TXOP, the first report frame is reported based on the third TXOP or a fourth TXOP, and the fourth TXOP is a TXOP obtained after the third TXOP.

In some embodiments, the communications unit 1010 is further configured to:
receive first indication information transmitted by the second device, where the first indication information is used to indicate a reporting manner of one or more measurement results.

In some embodiments, the reporting manner of a measurement result includes at least one of the following:
a first reporting manner, used to indicate that a measurement result is reported in a case when a measurement result reported by a sensing signal receiver is received;
a second reporting manner, used to indicate that, after a measurement instance ends, one or more measurement results received in the measurement instance or before a succeeding measurement instance are reported; and
a third reporting manner, used to indicate that, after all measurement results of each measurement instance in N measurement instances are obtained, all measurement results of each measurement instance in the N measurement instances are reported, where N is a positive integer.

In some embodiments, the first indication information is transmitted by using a first request frame, and the first request frame is used to request the sensing device working as a proxy to establish the at least one measurement setup.

In some embodiments, the first report frame includes a measurement result of a target measurement instance, the first report frame further includes second indication information, and the second indication information is used to indicate whether the first report frame is the last report frame carrying the measurement result of the target measurement instance.

In some embodiments, the first report frame is an action frame.

In some embodiments, the first report frame is a public action frame.

In some embodiments, the first report frame includes an action category field and a public action sub-category field, the action category field is used to indicate that the action frame is a public action frame, and a value of the public action sub-category field is a reserved value for indicating that the public action frame is used for a proxy to report a sensing measurement result.

In some embodiments, the first report frame is a sensing action frame.

In some embodiments, the first report frame includes an action category field and a sensing action sub-category field, a value of the action category field is a reserved value for indicating that an action frame is a sensing action frame, and the sensing action sub-category field is used to indicate that the sensing action frame is used for a proxy to report a sensing measurement result.

In some embodiments, the first report frame includes at least one measurement result field, and each measurement result field is used to carry a measurement result of a sensing signal receiver.

In some embodiments, the measurement result field includes at least one of the following fields:
a measurement instance identity field, used to indicate an identity of a measurement instance;
a measurement setup identity field, used to indicate an identity of a measurement setup;
a sensing signal transmitter identity field, used to indicate an identity of a sensing signal transmitter;
a sensing signal receiver identity field, used to indicate an identity of a sensing signal receiver;
a measurement timestamp field, used to indicate information about time at which measurement is performed;
a result data length field, used to indicate a length of measurement result data; and
a result data field, used to indicate measurement result data.

In some embodiments, the measurement result field further includes a control field, and the control field includes at least one of the following fields:
a measurement instance identity present field, used to indicate whether the measurement instance identity field presents in the measurement result field;
a measurement setup identity present field, used to indicate whether the measurement setup identity field presents in the measurement result field;
a sensing signal transmitter identity present field, used to indicate whether the sensing signal transmitter identity presents in the measurement result field;
a sensing signal receiver identity present field, used to indicate whether the sensing signal receiver identity presents in the measurement result field; and
a measurement timestamp present field, used to indicate whether the measurement timestamp field presents in the measurement result field.

In some embodiments, the sensing device is an access point device, and the second device is a station device.

In some embodiments, the communications unit 1010 is further configured to:
receive a protected sensing measurement report frame transmitted by at least one sensing signal receiver.

In some embodiments, the sensing device 1000 further includes:
a processing unit, configured to perform replay detection on the protected sensing measurement report frame based on a first replay counter, where the first replay counter is different from a second replay counter, and a count value of the second replay counter is used to determine whether another protected sensing-related management frame different from the first report frame that is protected and/or the protected sensing measurement report frame is a replayed frame.

In some embodiments, the processing unit is specifically configured to:
in a case in which a PN value in the protected sensing measurement report frame is greater than a value of the first replay counter, determine that the protected sensing measurement report frame is not a replayed frame, and update a count value of the first replay counter to the PN value in the protected sensing measurement report frame; or
in a case in which a PN value in the protected sensing measurement report frame is less than or equal to a value of the first replay counter, determine that the protected sensing measurement report frame is a replayed frame, and discard the protected sensing measurement report frame.

In some embodiments, a sensing action frame type corresponding to the first report frame that is protected or a sensing action frame type corresponding to the protected sensing measurement report frame or both are different from a sensing action frame type corresponding to the another protected sensing-related management frame.

In some embodiments, a counter mode with a cipher-block chaining message authentication code protocol CCMP header or a Galois/counter mode protocol GCMP header in each of the first report frame that is protected and the protected sensing measurement report frame includes a sensing field, and the sensing field is used to indicate a sensing action frame type corresponding to the first report frame that is protected and a sensing action frame type corresponding to the protected sensing measurement report frame.

In some embodiments, the communications unit 1010 is further configured to:
cache, by using a first receiving cache, a protected sensing measurement report frame transmitted by the at least one sensing signal receiver, where the first receiving cache is different from a second receiving cache, and the second receiving cache is used to cache another sensing-related management frame different from the first report frame that is protected and the protected sensing measurement report frame.

In some embodiments, the first report frame includes a sequence control field, the sequence control field includes a sequence number subfield, a sequence number space identifier used by the sequence number subfield belongs to a first sequence number space, the first sequence number space is different from a second sequence number space, the second sequence number space is used for another sensing-related management frame different from the first report frame and/or a sensing measurement report frame, and the sensing measurement report frame is used by a sensing signal receiver to report a measurement result.

Optionally, in some embodiments, the foregoing communications unit may be a communications interface or a transceiver, or an input/output interface of a communications chip or a system-on-chip.

It should be understood that the sensing device 1000 according to the embodiment of this application may correspond to the first device or the sensing by proxy device in method embodiments of this application, and the foregoing and other operations and/or functions of units in the sensing device 1000 are respectively used to implement corresponding procedures of the first device or the sensing by proxy device in the method 200 shown in FIG. 8 to FIG. 31. For brevity, details are not described herein again.

FIG. 33 is a schematic block diagram of a sensing device according to an embodiment of this application. A sensing device 1100 in FIG. 33 includes:
a communications unit 1110, configured to receive a first report frame transmitted by a first device, where the first report frame includes one or more measurement results of at least one measurement instance, one or more measurement results of each measurement instance includes one or more measurement results of at least one sensing signal receiver, the at least one measurement instance corresponds to at least one measurement setup, and the at least one measurement setup is established by the first device working as a proxy of the second device.

In some embodiments, the communications unit 1110 is further configured to:
receive the first report frame transmitted by the first device in a case when the first device receives a measurement result of at least one sensing signal receiver, where the first report frame includes the measurement result of the at least one sensing signal receiver.

In some embodiments, the first report frame is transmitted based on a first transmission opportunity TXOP or a second TXOP, where the measurement result of the at least one sensing signal receiver is received based on the first TXOP, and the second TXOP is a TXOP obtained after the first TXOP.

In some embodiments, the first TXOP is used for measurement of a second measurement instance, the measurement result of the at least one sensing signal receiver includes a measurement result of the second measurement instance and/or a measurement result of a first measurement instance, and the first measurement instance is a previous measurement instance of the second measurement instance.

In some embodiments, the communications unit 1110 is further configured to:
receive a first report frame transmitted by the first device after each measurement instance, where the first report frame includes one or more measurement results received in the measurement instance or before a succeeding measurement instance.

In some embodiments, the first report frame is transmitted based on a TXOP corresponding to the measurement instance; or
the first report frame is transmitted based on a TXOP obtained after the measurement instance.

In some embodiments, the at least one measurement instance includes a fourth measurement instance, and a succeeding measurement instance of the fourth measurement instance is a fifth measurement instance. A measurement result received in the fourth measurement instance or a measurement result received before the fifth measurement instance includes a measurement result of the fourth measurement instance and/or a measurement result of a third measurement instance, and the third measurement instance is a previous measurement instance of the fourth measurement instance.

In some embodiments, the communications unit 1110 is further configured to:
receive the first report frame transmitted by the first device in a case in which the first device receives all measurement results of each measurement instance in N measurement instances, where the first report frame includes all measurement results of each measurement instance in the N measurement instances, and N is a positive integer.

In some embodiments, the N is predefined or indicated by the sensing device.

In some embodiments, the N is indicated by the sensing device by using a first request frame, and the first request frame is used to request the first device working as a proxy to establish the at least one measurement setup.

In some embodiments, the last measurement instance in the N measurement instances is a sixth measurement instance, a measurement result of the sixth measurement instance is received based on a third TXOP, the first report frame is reported based on the third TXOP or a fourth TXOP, and the fourth TXOP is a TXOP obtained after the third TXOP.

In some embodiments, the communications unit 1110 is further configured to:
transmit first indication information to the first device, where the first indication information is used to indicate a reporting manner of one or more measurement results.

In some embodiments, the reporting manner of a measurement result includes at least one of the following:
a first reporting manner, used to indicate that a measurement result is reported in a case when a measurement result reported by a sensing signal receiver is received;
a second reporting manner, used to indicate that, after a measurement instance ends, one or more measurement results received in the measurement instance or before a succeeding measurement instance is reported; and
a third reporting manner, used to indicate that, after all measurement results of each measurement instance in N measurement instances are obtained, all measurement results of each measurement instance in the N measurement instances are reported, where N is a positive integer.

In some embodiments, the first indication information is transmitted by using a first request frame, and the first request frame is used to request the first device working as a proxy to establish the at least one measurement setup.

In some embodiments, the first report frame includes a measurement result of a target measurement instance, the first report frame further includes second indication information, and the second indication information is used to indicate whether the first report frame is the last report frame carrying the measurement result of the target measurement instance.

In some embodiments, the first report frame is an action frame.

In some embodiments, the first report frame is a public action frame.

In some embodiments, the first report frame includes an action category field and a public action sub-category field, the action category field is used to indicate that the action frame is a public action frame, and a value of the public action sub-category field is a reserved value for indicating that the public action frame is used for a proxy to report a sensing measurement result.

In some embodiments, the first report frame is a sensing action frame.

In some embodiments, the first report frame includes an action category field and a sensing action sub-category field, a value of the action category field is a reserved value for indicating that an action frame is a sensing action frame, and the sensing action sub-category field is used to indicate that the sensing action frame is used for a proxy to report a sensing measurement result.

In some embodiments, the first report frame includes at least one measurement result field, and each measurement result field is used to carry a measurement result of a sensing signal receiver.

In some embodiments, the measurement result field includes at least one of the following fields:
a measurement instance identity field, used to indicate an identity of a measurement instance;
a measurement setup identity field, used to indicate an identity of a measurement setup;
a sensing signal transmitter identity field, used to indicate an identity of a sensing signal transmitter;
a sensing signal receiver identity field, used to indicate an identity of a sensing signal receiver;
a measurement timestamp field, used to indicate information about time at which measurement is performed;
a result data length field, used to indicate a length of measurement result data; and
a result data field, used to indicate measurement result data.

In some embodiments, the measurement result field further includes a control field, and the control field includes at least one of the following fields:
a measurement instance identity present field, used to indicate whether the measurement instance identity field presents in the measurement result field;
a measurement setup identity present field, used to indicate whether the measurement setup identity field presents in the measurement result field;
a sensing signal transmitter identity present field, used to indicate whether the sensing signal transmitter identity presents in the measurement result field;
a sensing signal receiver identity present field, used to indicate whether the sensing signal receiver identity presents in the measurement result field; and
a measurement timestamp present field, used to indicate whether the measurement timestamp field presents in the measurement result field.

In some embodiments, the first device is an access point device, and the sensing device is a station device.

In some embodiments, the first report frame is a protected report frame, and the sensing device 1100 further includes:
a processing unit, configured to perform, based on a third replay counter, replay detection on the first report frame that is protected, where the third replay counter is different from a fourth replay counter, and a count value of the fourth replay counter is used to determine whether another protected sensing-related management frame different from the first report frame that is protected and/or a protected sensing measurement report frame is a replayed frame.

In some embodiments, the processing unit is further configured to:
in a case in which a PN value in the first report frame that is protected is greater than a value of the third replay counter, determine that the first report frame that is protected is not a replayed frame, and updating a count value of the third replay counter to the PN value in the first report frame that is protected; or
in a case in which a PN value in the first report frame that is protected is less than or equal to a value of the third replay counter, determine that the first report frame that is protected is a replayed frame, and discard the first report frame that is protected.

In some embodiments, a sensing action frame type corresponding to the first report frame that is protected or a sensing action frame type corresponding to the protected sensing measurement report frame or both are different from a sensing action frame type corresponding to the another protected sensing-related management frame.

In some embodiments, a counter mode with a cipher-block chaining message authentication code protocol CCMP header or a Galois/counter mode protocol GCMP header in each of the first report frame that is protected and the protected sensing measurement report frame includes a sensing field, and the sensing field is used to indicate a sensing action frame type corresponding to the first report frame that is protected and a sensing action frame type corresponding to the protected sensing measurement report frame.

In some embodiments, the communications unit 1110 is further configured to:
cache, by using a third receiving cache, the first report frame that is protected, where the third receiving cache is different from a fourth receiving cache, and the fourth receiving cache is used to cache another sensing-related management frame different from the first report frame that is protected and/or the protected sensing measurement report frame.

In some embodiments, the first report frame that is protected includes a sequence control field, the sequence control field includes a sequence number subfield, a sequence number space identifier used by the sequence number subfield belongs to a first sequence number space, the first sequence number space is different from a second sequence number space, the second sequence number space is used for another sensing-related management frame different from the first report frame and a sensing measurement report frame, and the sensing measurement report frame is used by a sensing signal receiver to report a measurement result.

Optionally, in some embodiments, the foregoing communications unit may be a communications interface or a transceiver, or an input/output interface of a communications chip or a system-on-chip.

It should be understood that the sensing device 1100 according to the embodiment of this application may correspond to the second device or the sensing by proxy requester in method embodiments of this application, and the foregoing and other operations and/or functions of units in the sensing device 1100 are respectively used to implement corresponding procedures of the second device or the sensing by proxy requester in the method 200 shown in FIG. 8 to FIG. 31. For brevity, details are not described herein again.

FIG. 34 is a schematic structural diagram of a communications device 600 according to an embodiment of this application. The communications device 600 shown in FIG. 34 includes a processor 610, and the processor 610 may invoke a computer program from a memory and run the computer program to implement a method in embodiments of this application.

Optionally, as shown in FIG. 34, the communications device 600 may further include a memory 620. The processor 610 may invoke a computer program from the memory 620 and run the computer program to cause the communications device 600 to implement a method in embodiments of this application.

The memory 620 may be a separate component independent of the processor 610, or may be integrated into the processor 610.

In some embodiments, as shown in FIG. 34, the communications device 600 may further include a transceiver 630. The processor 610 may control the transceiver 630 to communicate with another device, and specifically, may send information or data to the another device, or receive information or data sent by the another device.

The transceiver 630 may include a transmitter and a receiver. The transceiver 630 may further include an antenna, and a quantity of antennas may be one or more.

Optionally, the communications device 600 may specifically be the first device or the sensing by proxy device in embodiments of this application, and the communications device 600 may implement corresponding procedures implemented by the first device or the sensing by proxy device in methods in embodiments of this application. For brevity, details are not described herein again.

Optionally, the communications device 600 may specifically be the second device or the sensing by proxy requester in embodiments of this application, and the communications device 600 may implement corresponding procedures implemented by the second device or the sensing by proxy requester in methods in embodiments of this application. For brevity, details are not described herein again.

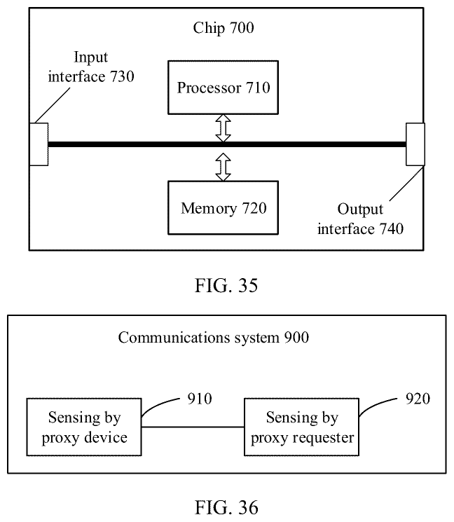

FIG. 35 is a schematic diagram of a structure of a chip according to an embodiment of this application. The chip 700 shown in FIG. 35 includes a processor 710, and the processor 710 may invoke a computer program from a memory and run the computer program to implement a method in embodiments of this application.

Optionally, as shown in FIG. 35, the chip 700 may further include a memory 720. The processor 710 may invoke a computer program from the memory 720 and run the computer program to implement a method in embodiments of this application.

The memory 720 may be a separate component independent of the processor 710, or may be integrated into the processor 710.

Optionally, the chip 700 may further include an input interface 730. The processor 710 may control the input interface 730 to communicate with another device or chip, and specifically, may obtain information or data transmitted by the another device or chip.

Optionally, the chip 700 may further include an output interface 740. The processor 710 may control the output interface 740 to communicate with another device or chip, and specifically, may output information or data to the another device or chip.

Optionally, the chip may be applied to the first device or the sensing by proxy device in embodiments of this application, and the chip may implement corresponding procedures implemented by the first device or the sensing by proxy device in methods in embodiments of this application. For brevity, details are not described herein again.

Optionally, the chip may be applied to the second device or the sensing by proxy requester in embodiments of this application, and the chip may implement corresponding procedures implemented by the second device or the sensing by proxy requester in methods in embodiments of this application. For brevity, details are not described herein again.

It should be understood that the chip mentioned in this embodiment of this application may alternatively be referred to as a system-level chip, a system chip, a chip system, or a system-on-chip.

FIG. 36 is a schematic block diagram of a communications system 900 according to an embodiment of this application. As shown in FIG. 36, the communications system 900 includes a sensing by proxy device 910 and a sensing by proxy requester 920.

The sensing by proxy device 910 may be used to implement corresponding functions implemented by the first device or the sensing by proxy device in foregoing methods, and the sensing by proxy requester 920 may be used to implement corresponding functions implemented by the second device or the sensing by proxy requester in foregoing methods. For brevity, details are not described herein again.

It should be understood that, a processor in embodiments of this application may be an integrated circuit chip having a signal processing capability. In an implementation process, the steps in the foregoing method embodiments may be performed by using an integrated logic circuit of hardware of the processor or instructions in a software form. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor may implement or execute the methods, steps, and logical block diagrams disclosed in embodiments of this application. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and completes the steps of the foregoing methods in combination with hardware in the processor.

It may be understood that the memory in embodiments of this application may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DR RAM). It should be noted that, the memory in the systems and methods described in this specification includes but is not limited to these memories and any memory of another proper type.

It should be understood that, by way of example but not limitative description, for example, the memory in this embodiment of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synch link DRAM, SLDRAM), a direct Rambus random access memory (Direct Rambus RAM, DR RAM), or the like. In other words, the memory in this embodiment of this application includes but is not limited to these memories and any memory of another proper type.

An embodiment of this application further provides a computer-readable storage medium, configured to store a computer program.

Optionally, the computer-readable storage medium may be applied to the first device or the sensing by proxy device in embodiments of this application, and the computer program causes a computer to execute corresponding processes implemented by the first device or the sensing by proxy device in methods in embodiments of this application. For brevity, details are not described herein again.

Optionally, the computer-readable storage medium may be applied to the second device or the sensing by proxy requester in embodiments of this application, and the computer program causes a computer to execute corresponding processes implemented by the second device or the sensing by proxy requester in methods in embodiments of this application. For brevity, details are not described herein again.

An embodiment of this application further provides a computer program product, including computer program instructions.

Optionally, the computer program product may be applied to the first device or sensing by proxy device in embodiments of this application, and the computer program instructions cause a computer to execute corresponding processes implemented by the first device or the sensing by proxy device in methods in embodiments of this application. For brevity, details are not described herein again.

Optionally, the computer program product may be applied to the second device or the sensing by proxy requester in embodiments of this application, and the computer program instructions cause a computer to execute corresponding procedures implemented by the second device or the sensing by proxy requester in methods in embodiments of this application. For brevity, details are not described herein again.

An embodiment of this application further provides a computer program.

Optionally, the computer program may be applied to the first device or the sensing by proxy device in embodiments of this application. When the computer program runs on a computer, the computer executes corresponding processes implemented by the first device or the sensing by proxy device in methods in embodiments of this application. For brevity, details are not described herein again.

Optionally, the computer program may be applied to a second device or a sensing by proxy requester in embodiments of this application. When the computer program is run on a computer, the computer executes the corresponding procedures implemented by the second device or the sensing by proxy requester in methods in embodiments of this application. For brevity, details are not described herein again.

A person of ordinary skill in the art may be aware that, units and algorithm steps in examples described in combination with embodiments disclosed in this specification can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

Those skilled in the art may clearly understand that, for the purpose of convenient and brief description, for detailed working processes of the foregoing system, apparatus, and unit, reference may be made to the corresponding processes in the foregoing method embodiments, and details are not described herein again.

In the several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communications connections may be implemented by using some interfaces. The indirect couplings or communications connections between apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objective of the solutions of the embodiments.

In addition, functional units in embodiments of this application may be integrated into one processing unit, or each of the units may exist alone physically, or two or more units may be integrated into one unit.

When the functions are implemented in a form of a software function unit and sold or used as an independent product, the functions may be stored in a computer-readable storage medium. Based on such an understanding, the technical solutions of this application essentially, or the part contributing to the conventional technology, or some of the technical solutions may be implemented in the form of a software product. The computer software product is stored in a storage medium and includes several instructions for instructing a computer device (which may be a personal computer, a server, a network device, or the like) to execute all or some of the steps of the methods described in embodiments of this application. The foregoing storage medium includes various media that may store a program code, such as a USB flash drive, a removable hard disk, a read-only memory (ROM), a random access memory (RAM), a magnetic disk, or an optical disk.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application should be subject to the protection scope of the claims.

What is claimed is:

1. A sensing device, wherein the sensing device is a first device, wherein the sensing device comprises a processor and a memory, wherein the memory is configured to store a computer program, and the processor is configured to invoke the computer program stored in the memory and run the computer program, to cause the sensing device to execute the method comprising:
transmitting, a first report frame to a second device, wherein the first report frame comprises one or more measurement results of at least one measurement instance, the one or more measurement results of each measurement instance comprise one or more measurement results of at least one sensing signal receiver, the at least one measurement instance corresponds to at least one measurement setup, and the at least one measurement setup is established by the first device working as a proxy of the second device.

2. The sensing device according to claim 1, wherein the transmitting, a first report frame to a second device comprises:
transmitting, a first report frame to the second device after each measurement instance, wherein the first report frame comprises one or more measurement results received in the measurement instance or before a succeeding measurement instance.

3. The sensing device according to claim 2, wherein the transmitting, a first report frame to the second device after each measurement instance comprises:
transmitting the first report frame to the second device based on a transmission opportunity (TXOP) corresponding to the measurement instance; or
transmitting the first report frame to the second device based on a TXOP obtained after the measurement instance.

4. The sensing device according to claim 2, wherein the at least one measurement instance comprises a fourth measurement instance, a succeeding measurement instance of the fourth measurement instance is a fifth measurement instance, one or more measurement results received in the fourth measurement instance or one or more measurement results received before the fifth measurement instance comprise one or more measurement results of the fourth measurement instance and/or one or more measurement results of a third measurement instance, and the third measurement instance is a previous measurement instance of the fourth measurement instance.

5. The sensing device according to claim 1, wherein the transmitting, a first report frame to a second device comprises:
transmitting, the first report frame to the second device in a case of receiving all measurement results of each measurement instance in N measurement instances, wherein the first report frame comprises all measurement results of each measurement instance in the N measurement instances, and N is a positive integer.

6. The sensing device according to claim 5, wherein the last measurement instance in the N measurement instances is a sixth measurement instance, one or more measurement results of the sixth measurement instance are received based on a third TXOP, the first report frame is reported based on the third TXOP or a fourth TXOP, and the fourth TXOP is a TXOP obtained after the third TXOP.

7. The sensing device according to claim 1, wherein the first report frame comprises one or more measurement results of a target measurement instance, the first report frame further comprises second indication information, and the second indication information is used to indicate whether the first report frame is the last report frame carrying the one or more measurement results of the target measurement instance.

8. The sensing device according to claim 1, wherein the method further comprises:
receiving, a protected sensing measurement report frame transmitted by at least one sensing signal receiver; and
performing, replay detection on the protected sensing measurement report frame based on a first replay counter, wherein the first replay counter is different from a second replay counter, and a count value of the second replay counter is used to determine whether another protected sensing-related management frame different from the first report frame that is protected and/or the protected sensing measurement report frame is a replayed frame.

9. A sensing device, wherein the sensing device is a second device, wherein the sensing device comprises a processor and a memory, wherein the memory is configured to store a computer program, and the processor is configured to invoke the computer program stored in the memory and run the computer program, to cause the sensing device to execute the method comprising:
receiving, a first report frame transmitted by a first device, wherein the first report frame comprises one or more measurement results of at least one measurement instance, one or more measurement results of each measurement instance comprises one or more measurement results of at least one sensing signal receiver, the at least one measurement instance corresponds to at least one measurement setup, and the at least one measurement setup is established by the first device working as a proxy of the second device.

10. The sensing device according to claim 9, wherein the receiving, a first report frame transmitted by a first device comprises:
receiving, a first report frame transmitted by the first device after each measurement instance, wherein the first report frame comprises one or more measurement results received in the measurement instance or before a succeeding measurement instance.

11. The sensing device according to claim 10, wherein the first report frame is transmitted based on a transmission opportunity (TXOP) corresponding to the measurement instance; or
the first report frame is transmitted based on a TXOP obtained after the measurement instance.

12. The sensing device according to claim 10, wherein the at least one measurement instance comprises a fourth measurement instance, a succeeding measurement instance of the fourth measurement instance is a fifth measurement instance, one or more measurement results received in the fourth measurement instance or one or more measurement results received before the fifth measurement instance comprise one or more measurement results of the fourth measurement instance and/or one or more measurement results of a third measurement instance, and the third measurement instance is a previous measurement instance of the fourth measurement instance.

13. The sensing device according to claim 9, wherein the receiving, a first report frame transmitted by a first device comprises:
receiving, the first report frame transmitted by the first device in a case in which the first device receives all measurement results of each measurement instance in N measurement instances, wherein the first report frame comprises all measurement results of each measurement instance in the N measurement instances, and N is a positive integer.

14. The sensing device according to claim 13, wherein the last measurement instance in the N measurement instances is a sixth measurement instance, one or more measurement results of the sixth measurement instance are received based on a third TXOP, the first report frame is reported based on the third TXOP or a fourth TXOP, and the fourth TXOP is a TXOP obtained after the third TXOP.

15. The sensing device according to claim 9, wherein the first report frame comprises one or more measurement results of a target measurement instance, the first report frame further comprises second indication information, and the second indication information is used to indicate whether the first report frame is the last report frame carrying the one or more measurement results of the target measurement instance.

16. The sensing device according to claim 9, wherein the first report frame is an action frame;
wherein the first report frame is a public action frame;
wherein the first report frame comprises an action category field and a public action sub-category field, the action category field is used to indicate that the action frame is the public action frame, and a value of the public action sub-category field is a reserved value for indicating that the public action frame is used for a proxy to report a sensing measurement result.

17. The sensing device according to claim 9, wherein the first report frame comprises at least one measurement result field, and each measurement result field is used to carry a measurement result of a sensing signal receiver.

18. The sensing device according to claim 17, wherein the measurement result field comprises at least one of following fields:
a measurement instance identity field, used to indicate an identity of a measurement instance;
a measurement setup identity field, used to indicate an identity of a measurement setup;
a sensing signal transmitter identity field, used to indicate an identity of a sensing signal transmitter;
a sensing signal receiver identity field, used to indicate an identity of a sensing signal receiver;
a measurement timestamp field, used to indicate information about time at which measurement is performed;
a result data length field, used to indicate a length of measurement result data; and
a result data field, used to indicate measurement result data;
wherein the measurement result field further comprises a control field, and the control field comprises at least one of following fields:
a measurement instance identity present field, used to indicate whether the measurement instance identity field presents in the measurement result field;
a measurement setup identity present field, used to indicate whether the measurement setup identity field presents in the measurement result field;
a sensing signal transmitter identity present field, used to indicate whether the sensing signal transmitter identity presents in the measurement result field;
a sensing signal receiver identity present field, used to indicate whether the sensing signal receiver identity presents in the measurement result field; and
a measurement timestamp present field, used to indicate whether the measurement timestamp field presents in the measurement result field.

19. The sensing device according to claim 9, wherein the first device is an access point device, and the second device is a station device.

20. The sensing device according to claim 9, wherein the first report frame is a protected report frame, and the method further comprises:
performing, by the second device based on a third replay counter, replay detection on the first report frame that is protected, wherein the third replay counter is different from a fourth replay counter, and a count value of the fourth replay counter is used to determine whether another protected sensing-related management frame different from the first report frame that is protected and/or a protected sensing measurement report frame is a replayed frame.
